(19) United States
(12) Patent Application Publication
(10) Pub. No.: US 2026/0300954 A1
(43) Pub. Date: Oct. 1, 2026

(54) System and Method for Persistent Identity-Based Messaging Channel Optimization and Delivery

(71) Applicant: TapText llc, Coral Springs, FL (US)

(72) Inventor: Steve Doumar, Fort Lauderdale, FL (US)

(21) Appl. No.: 19/696,642

(22) Filed: Jun. 3, 2026

Related U.S. Application Data
(63) Continuation-in-part of application No. 18/631,042, filed on Apr. 10, 2024, now Pat. No. 12,657,570.
Application No. 18/631,042 is a continuation-in-part of application No. 18/593,911, filed on Mar. 3, 2024, now Pat. No. 12,182,794.
Application No. 18/593,911 is a continuation-in-part of application No. 18/185,993, filed on Mar. 17, 2023, now Pat. No. 11,995,639.
Application No. 18/185,993 is a continuation of application No. 17/409,841, filed on Aug. 24, 2021, now Pat. No. 11,610,193.
Application No. 17/409,841 is a continuation-in-part of application No. 17/360,731, filed on Jun. 28, 2021, now Pat. No. 11,871,308.
Application No. 17/360,731 is a continuation-in-part of application No. 17/229,251, filed on Apr. 13, 2021, now abandoned.
Application No. 17/229,251 is a continuation-in-part of application No. 17/209,474, filed on Mar. 23, 2021, now Pat. No. 11,599,916.
Application No. 17/209,474 is a continuation-in-part of application No. 17/208,059, filed on Mar. 22, 2021, now Pat. No. 11,562,407.
Application No. 17/208,059 is a continuation-in-part of application No. 17/191,977, filed on Mar. 4, 2021, now abandoned.
Application No. 17/191,977 is a continuation-in-part of application No. 17/190,260, filed on Mar. 2, 2021, now Pat. No. 11,532,020.
Application No. 17/190,260 is a continuation-in-part of application No. 17/153,426, filed on Jan. 20, 2021, now abandoned.
Application No. 17/360,731 is a continuation-in-part of application No. 17/085,931, filed on Oct. 30, 2020, now Pat. No. 11,055,736.
Application No. 17/085,931 is a continuation-in-part of application No. 16/693,275, filed on Nov. 23, 2019, now Pat. No. 11,270,354.
(60) Provisional application No. 62/879,862, filed on Jul. 29, 2019.
(60) Provisional application No. 62/883,360, filed on Aug. 6, 2019.
(60) Provisional application No. 62/904,568, filed on Sep. 23, 2019.
(60) Provisional application No. 62/940,607, filed on Nov. 26, 2019.
(60) Provisional application No. 62/963,368, filed on Jan. 20, 2020.
(60) Provisional application No. 62/963,379, filed on Jan. 20, 2020.
(60) Provisional application No. 62/963,368, filed on Jan. 20, 2020.
(60) Provisional application No. 62/963,379, filed on Jan. 20, 2020.
(60) Provisional application No. 62/963,568, filed on Jan. 21, 2020.
(60) Provisional application No. 62/965,626, filed on Jan. 24, 2020.
(60) Provisional application No. 62/965,626, filed on Jan. 24, 2020.
(60) Provisional application No. 62/994,219, filed on Mar. 24, 2020.
(60) Provisional application No. 62/994,219, filed on Mar. 24, 2020.
(60) Provisional application No. 63/022,190, filed on May 8, 2020.
(60) Provisional application No. 63/022,190, filed on May 8, 2020.
(60) Provisional application No. 63/025,287, filed on May 15, 2020.
(60) Provisional application No. 63/025,287, filed on May 15, 2020.
(60) Provisional application No. 63/040,610, filed on Jun. 18, 2020.
(60) Provisional application No. 63/040,610, filed on Jun. 18, 2020.
(60) Provisional application No. 63/154,357, filed on Feb. 26, 2021.
(60) Provisional application No. 63/166,391, filed on Mar. 26, 2021.
(60) Provisional application No. 63/211,496, filed on Jun. 16, 2021.

(51) Int. Cl. G06Q 20/32; G06Q 20/40; H04W 4/80

(52) U.S. Cl. CPC G06Q 20/3276; G06Q 20/4014; H04W 4/80

(57) ABSTRACT

A system and method for persistent identity-based messaging channel optimization and delivery uses an interaction control server and messaging gateway to facilitate communications between users and businesses using diverse messaging protocols while maintaining persistent identity profiles and session continuity. Phone numbers serve as persistent identity anchors that accumulate interaction history, opt-in state, and derived preferences across multiple campaigns and sessions. Multi-state opt-in models govern messaging eligibility with graduated consent levels. The system dynamically negotiates messaging protocol capabilities with external platform services, evaluates capabilities against message requirements and verification status, and selects optimal protocols including RCS, SMS, or MMS. Capability-aware message construction adapts formatting to selected protocols while preserving interaction intent. Session identifiers enable seamless protocol transitions with automatic message regeneration and context preservation when delivery failures occur, maintaining conversation continuity despite channel changes and ensuring progressive personalization without requiring repeated user confirmation.

### CROSS-REFERENCE TO RELATED APPLICATIONS

Priority is claimed in the application data sheet to the following patents or patent applications, each of which is expressly incorporated herein by reference in its entirety:
Ser. No. 19/683,929
Ser. No. 19/441,824
Ser. No. 17/874,209
Ser. No. 17/865,814
Ser. No. 17/229,251
63/166,391
Ser. No. 17/209,474
Ser. No. 17/208,059
Ser. No. 17/191,977
Ser. No. 17/190,260
Ser. No. 17/153,426
63/154,357
Ser. No. 18/631,042
Ser. No. 18/593,911
63/519,562
Ser. No. 18/185,993
Ser. No. 17/409,841
Ser. No. 17/360,731
Ser. No. 17/229,251
Ser. No. 17/085,931
63/211,496
63/519,559

### BACKGROUND OF THE INVENTION

### Field of the Art

The present invention relates to the field of computer-based communication systems, and more specifically to the field of marketing and promotions using computer-based communication systems.

### Discussion of the State of the Art

Modern customer engagement systems rely heavily on messaging-based interactions to connect potential customers with businesses. However, current systems treat each interaction as an isolated event with ephemeral context that does not persist beyond individual sessions. When a customer responds to a digital advertisement or marketing message, existing systems typically generate context for that specific interaction but fail to maintain that context for future engagements, requiring customers to repeatedly provide contact information, specify communication preferences, and re-establish their interests across multiple touchpoints. Furthermore, current messaging systems lack a unified approach to managing user identity across different communication channels and campaigns. A customer who interacts via different campaigns or at different times is often treated as a new or unknown user rather than being recognized based on persistent identity, preventing systems from accumulating contextual intelligence about customer preferences and behaviors over time.

Additionally, existing systems do not dynamically determine communication channel eligibility based on structured, multi-state opt-in models and real-time capability negotiation. When enhanced messaging protocols such as Rich Communication Services (RCS) are available, current systems either fail to utilize these capabilities or apply them without systematic evaluation of consent levels, device capabilities, carrier support, and verification status. There is no integrated mechanism to evaluate whether a user's opt-in state authorizes enhanced messaging features, to query external platform services for current capability information, to conditionally enable rich features based on negotiated capabilities, and to automatically adapt message formatting when enhanced protocols are unavailable, all while maintaining conversation continuity through session identifiers that preserve context across protocol transitions. Current systems lack the intelligence to seamlessly transition between protocols when delivery failures occur, resulting in dropped conversations, lost context, and fragmented user experiences when technical constraints prevent use of initially selected protocols.

What is needed is a system and method for persistent identity-based messaging channel optimization and delivery that uses phone numbers as persistent identity anchors to accumulate contextual intelligence over time, that employs multi-state opt-in models to enforce graduated messaging permissions, that dynamically negotiates messaging protocol capabilities with external platform services and selects optimal protocols based on consent and capability evaluation, that constructs capability-aware messages adapted to selected protocol constraints while preserving interaction intent, and that maintains session continuity across protocol transitions through session identifiers that enable seamless fallback and context preservation when delivery failures necessitate protocol changes.

### SUMMARY OF THE INVENTION

Accordingly, the inventor has conceived and reduced to practice a system and method for persistent identity-based messaging channel optimization and delivery.

According to a preferred embodiment, a system for persistent identity-based messaging channel optimization and delivery, comprising: a user device comprising at least a first plurality of programming instructions stored in the memory of, and operating on at least one processor of, a first computing device, wherein the first plurality of programming instructions, when operating on the at least one processor, cause the first computing device to: interact with digital activation assets over a network; transmit an interaction comprising a phone number and contextual data; and receive messages via multiple messaging protocols; a messaging gateway comprising at least a second plurality of programming instructions stored in the memory of, and operating on at least one processor of, a second computing device, wherein the second plurality of programming instructions, when operating on the at least one processor, cause the second computing device to: support multiple messaging protocols; negotiate capabilities with external messaging platform services; receive messaging instructions from an interaction control server; and deliver messages to the user device using a selected messaging protocol; and an interaction control server comprising at least a third plurality of programming instructions stored in the memory of, and operating on at least one processor of, a third computing device, wherein the third plurality of programming instructions, when operating on the at least one processor, cause the third computing device to: receive the interaction from the user device comprising the phone number and contextual data; maintain persistent user identity profiles anchored to phone numbers as primary identifiers; capture an opt-in event associated with the interaction; maintain multi-state opt-in information governing messaging eligibility; determine messaging protocol eligibility based on the multi-state opt-in information and capabilities retrieved from external messaging platform services; select a messaging protocol based on the determined eligibility; construct capability-aware messages adapted to the selected messaging protocol; assign session identifiers to interactions and maintain session state; instruct the messaging gateway to deliver messages using the selected messaging protocol; and route user interactions to one or more downstream lead destinations.

According to another preferred embodiment, a method for persistent identity-based messaging channel optimization and delivery, comprising the steps of: interacting with digital activation assets over a network, using a user device; transmitting an interaction comprising a phone number and contextual data, using a user device; receiving messages via multiple messaging protocols, using a user device; supporting multiple messaging protocols, using a messaging gateway; negotiating capabilities with external messaging platform services, using a messaging gateway; receiving messaging instructions from an interaction control server, using a messaging gateway; delivering messages to the user device using a selected messaging protocol, using a messaging gateway; receiving the interaction from the user device comprising the phone number and contextual data, using an interaction control server; maintaining persistent user identity profiles anchored to phone numbers as primary identifiers, using an interaction control server; capturing an opt-in event associated with the interaction, using an interaction control server; maintaining multi-state opt-in information governing messaging eligibility, using an interaction control server; determining messaging protocol eligibility based on the multi-state opt-in information and capabilities retrieved from external messaging platform services, using an interaction control server; selecting a messaging protocol based on the determined eligibility, using an interaction control server; constructing capability-aware messages adapted to the selected messaging protocol, using an interaction control server; assigning session identifiers to interactions and maintain session state, using an interaction control server; instructing the messaging gateway to deliver messages using the selected messaging protocol, using an interaction control server; and routing user interactions to one or more downstream lead destinations, using an interaction control server.

### BRIEF DESCRIPTION OF THE DRAWING FIGURES

FIG. 1 is a block diagram illustrating an exemplary system architecture for a dynamic-link communication platform.

FIG. 2 is a block diagram illustrating an exemplary architecture for message gateway.

FIG. 3 is a block diagram illustrating an exemplary use of a message gateway.

FIG. 4 is a block diagram illustrating an exemplary architecture for a management service.

FIG. 5 is a block diagram illustrating exemplary data within one or more data stores.

FIG. 6 is a system diagram illustrating an RCS-based lead redirection and opt-in management system.

FIG. 7 is a method diagram illustrating steps for delivering digital activation assets to users and capturing user interaction with such assets to initiate opt-in and engagement flows, according to an embodiment.

FIG. 8 is a method diagram illustrating steps for phone-number-centric identity establishment, persistent tracking, and contextual enrichment over time, according to an embodiment.

FIG. 9 is a system diagram illustrating an enhanced interaction control server architecture with six-service addition, according to an embodiment.

FIG. 10 is a block diagram illustrating a persistent identity profile data structure, according to an embodiment.

FIG. 11 is a state diagram illustrating a multi-state opt-in state machine, according to an embodiment.

FIG. 12 is a method diagram illustrating steps for channel eligibility determination process flow, according to an embodiment.

FIG. 13 is a sequence diagram illustrating the RCS capability negotiation detailed sequence, according to an embodiment.

FIG. 14 is a flowchart diagram illustrating capability-aware message construction for dual protocols, according to an embodiment.

FIG. 15 is a method diagram illustrating steps for maintaining session continuity and seamless fallback during RCS to SMS channel transition, according to an embodiment.

FIG. 16 is a method diagram illustrating steps for opt-in-gated RCS channel eligibility determination and capability negotiation, according to an embodiment.

FIG. 17 is a data flow diagram illustrating cross-session and cross-campaign identity persistence, according to an embodiment.

FIG. 18 illustrates an exemplary computing environment on which an embodiment described herein may be implemented.

### DETAILED DESCRIPTION OF THE INVENTION

The inventor has conceived and reduced to practice, a system and method for persistent identity-based messaging channel optimization and delivery that fundamentally transforms how businesses maintain context and optimize communication channels across user interactions. By anchoring all identity data to phone numbers as persistent identifiers, the system creates a stable foundation for accumulating contextual intelligence that transcends individual sessions, campaigns, and time periods. Unlike conventional systems that treat each interaction as an isolated event with ephemeral context that disappears when a session ends, this phone-number-centric approach enables continuous accumulation of interaction history, device associations, communication preferences, opt-in records, and engagement patterns that compound in value with each successive user engagement. The persistent identity architecture eliminates the friction of requiring users to repeatedly provide contact information, specify communication preferences, or re-establish their interests across multiple touchpoints, instead recognizing returning users immediately based on their phone number and applying all accumulated intelligence to optimize each new interaction.

The multi-state opt-in framework represents a significant advancement over binary consent models by treating opt-in as a graduated authorization structure comprising discrete consent levels that unlock progressively enhanced messaging capabilities. Rather than simply tracking whether a user has opted in or not, the system maintains detailed opt-in state information indicating whether the user has granted no consent, basic messaging permission authorizing SMS and MMS communications, enhanced messaging consent enabling Rich Communication Services with interactive features, or verified branded messaging permission allowing business-verified branded communications. This graduated model enables precise enforcement of messaging eligibility based on the specific consent level achieved, ensures that enhanced protocol features are used only when explicitly authorized by user consent, and creates natural progression paths where users who demonstrate deeper engagement can be offered opportunities to unlock richer communication experiences. The opt-in state manager captures comprehensive contextual metadata at each consent state transition including activation asset identifiers, campaign parameters, timestamps, device characteristics, and consent scope specifications, creating an auditable record of consent evolution that supports regulatory compliance while enabling sophisticated analysis of consent patterns to optimize opt-in strategies.

Dynamic capability negotiation with external Rich Communication Services platform services enables the system to make protocol selection decisions based on real-time technical feasibility rather than assumptions or stale capability data. When enhanced messaging is authorized by opt-in state, the channel eligibility service coordinates with the RCS platform interface within the messaging gateway to query capability endpoints operated by carriers, RCS business messaging providers, or RCS platform operators, requesting detailed information about whether RCS is supported for the specific phone number in question and what features are available. The capability response provides authoritative data about support for rich cards, interactive buttons, suggested replies, rich media, branded sender identity, persistent sessions, and any limitations or restrictions, enabling the system to evaluate whether RCS capabilities are sufficient for the intended message interaction. This dynamic negotiation occurs at the time of each engagement rather than relying on cached capability information that may have become outdated due to device upgrades, carrier network changes, or platform configuration updates, ensuring that protocol selection decisions reflect current technical reality and maximize the likelihood of successful message delivery using the richest protocol that technical constraints permit.

Capability-aware message construction bridges the gap between interaction intent and protocol constraints by automatically adapting message formatting and features to match the selected protocol while preserving the core purpose and functionality of the communication. When RCS is selected based on capability negotiation and opt-in authorization, the message constructor formats content using rich card layouts that structure information visually, incorporates interactive buttons that enable user actions through simple taps, applies branded sender identity elements that display business name and verification badges, and includes rich media such as images or videos that enhance engagement. When SMS or MMS is selected as a fallback protocol due to RCS unavailability or opt-in limitations, the same interaction intent is expressed through adapted formatting that converts rich layouts to plain text descriptions, replaces interactive buttons with numbered reply options that instruct users to respond with specific numbers, preserves branding through text-based business identification, and simplifies or omits media content while retaining essential information. This dual-path construction approach enables the system to maintain consistent interaction logic across different protocol capabilities without requiring separate message authoring for each protocol, and ensures that all users receive valuable and actionable communications regardless of their device or carrier limitations.

Session continuity mechanisms maintain uninterrupted conversation flow and complete context preservation when protocol transitions become necessary due to delivery failures or capability changes during active messaging sessions. Each interaction is assigned a session identifier that serves as a persistent thread linking all messages, user responses, and system actions within a conversation, enabling the system to track and maintain context across multiple exchanges and potential protocol switches. When a Rich Communication Services delivery attempt fails because the device is no longer RCS-capable, the RCS service is unavailable, or network issues prevent delivery, the messaging gateway sends a failure notification to the interaction control server including the session identifier and information about available alternative protocols. The session continuity manager uses the session identifier to retrieve complete session state including all prior messages exchanged, user actions taken, system responses provided, and attribution metadata, ensuring that no context is lost when transitioning to a fallback protocol. The system automatically regenerates the failed message for SMS or MMS delivery while maintaining the same session identifier, preserving conversation threading despite the underlying protocol change. User responses received via the fallback protocol are matched back to the existing session using the session identifier, enabling the conversation to continue seamlessly with full context maintained across the protocol transition. This session continuity architecture ensures that users experience uninterrupted engagement even when technical constraints necessitate channel changes, that no information or context is lost during protocol transitions, and that complete interaction history is preserved for analytics and downstream system integration.

The compounding intelligence effect created through persistent phone-number-anchored identity combined with continuous contextual enrichment produces progressively improving user experiences and increasingly effective engagement strategies over time. Each interaction with a user contributes new data points to their identity profile including observed protocol preferences, successful communication timing patterns, demonstrated product interests, and engagement responsiveness indicators. The personalization and inference manager applies behavioral analysis, pattern recognition, and machine learning techniques to extract higher-level insights from accumulated interaction data, deriving implicit preferences about optimal communication times, preferred devices and protocols, content preferences, and behavioral propensities without requiring explicit user surveys or configuration. These derived preferences are stored persistently with the identity profile and automatically applied to optimize all future interactions, creating a virtuous cycle where each engagement both benefits from and contributes to accumulated intelligence. Users with extensive interaction histories receive communications through their preferred protocols at their optimal times on their preferred devices with content personalized to their demonstrated interests, all determined algorithmically from observed behavior patterns rather than through explicit user effort. This continuous intelligence accumulation creates substantial switching costs for users who have established rich interaction histories, provides businesses with competitive advantages through proprietary knowledge about individual user preferences that cannot be replicated by competitors lacking equivalent historical data, and enables the system to deliver increasingly frictionless and relevant experiences as relationships mature over time.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Conceptual Architecture

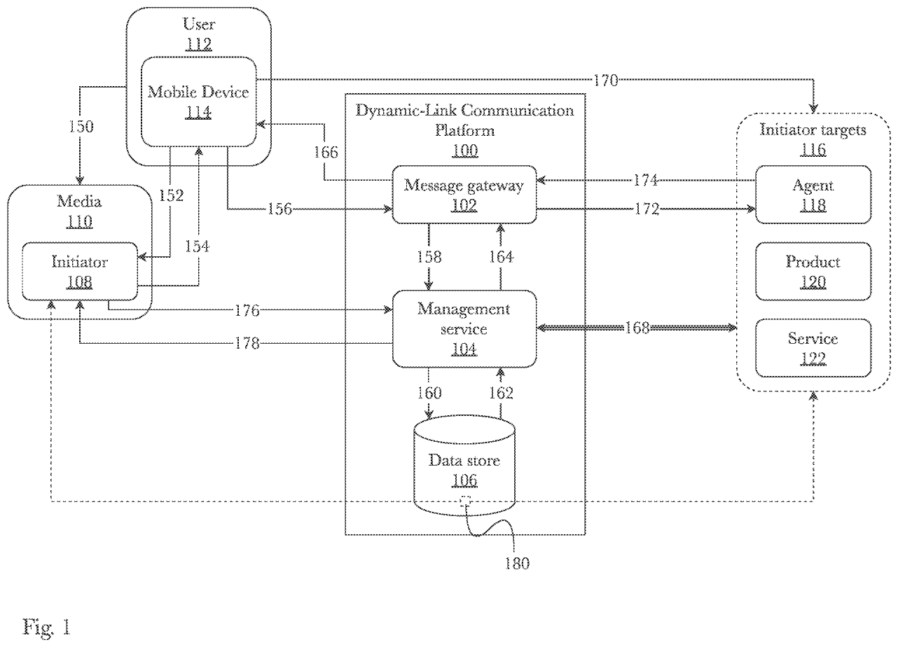

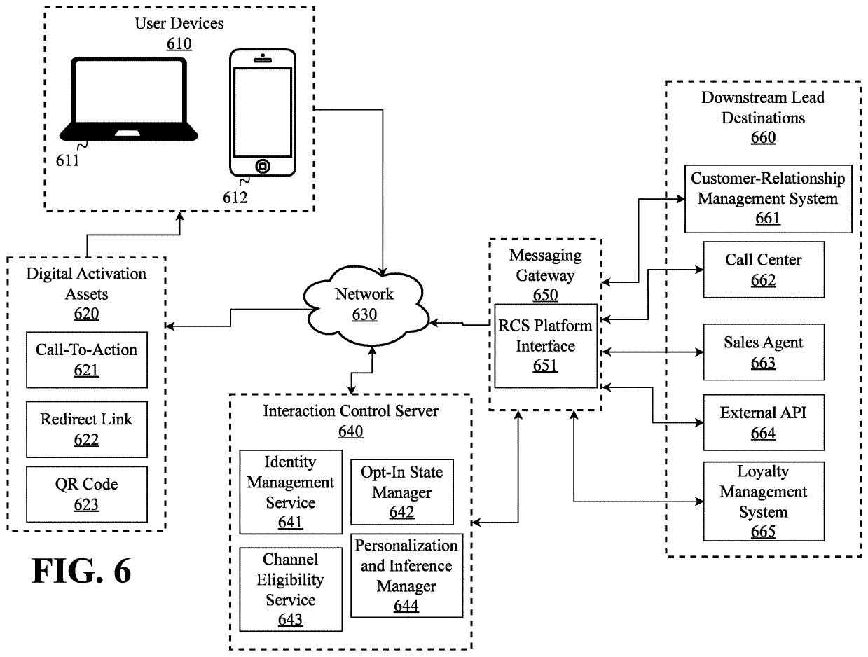

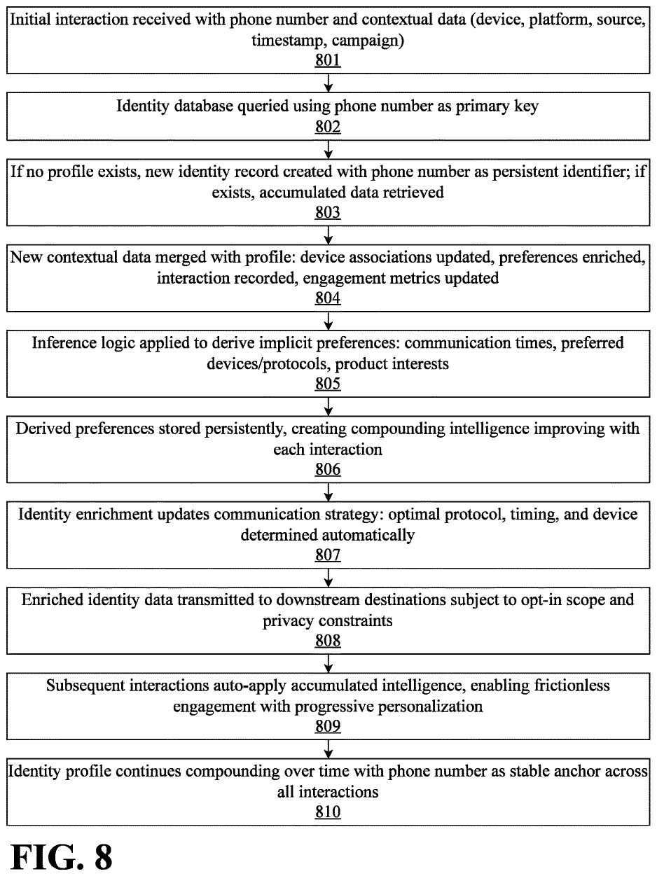

FIG. 1 is a block diagram illustrating an exemplary system architecture for a dynamic-link communication platform 100. Dynamic-link communication platform 100 links an initiator 108 with some type of content or call-to-action associated with a target product or service 116. An initiator 108 may take on many forms, a preferred form being a QR code, however other forms are anticipated in a non-exhaustive list in FIG. 8. The content served may also take many forms, a preferred form being a text or URL associated with a product 120 or service 122, however other forms are anticipated in a non-exhaustive list in FIG. 6. Actions are typically, but not limited to, communicating with some type of agent 118, be it a sales agent, technical support agent, or other types of representatives.

Initialization of dynamic-link communication platform 100 comprises storing content and rules associated with a product 120 or service 122 in some form of computer memory 106, i.e., in a database, federated data store, or distributed ledger, etc. The content and rules are assigned an initiator ID that is unique to that product 120 or service 122 and everything related to that product 120 or service 122 (e.g., content, rules, initiator ID, etc.) is called a campaign 180. The initiator ID may be autogenerated by an algorithm, or taken sequentially from a list, or other methods known to those in the art. Additionally, neither the content nor the rules together are a requirement, but each campaign must have at least one or the other or both. For example, a campaign for a product sold online may have no rules and the only content is a URL to the product page for that product. Or in another example, a marketing campaign attempting to get users 112 to speak to a sales representative may have only a set of rules that forward the user's 112 phone number to a phone number of the business. However, in some situations, there may be content and rules, whereby it may be possible to only forward the content based on some part of the user's 112 metadata embedded in the auto-populated message.

Other rules may comprise routing instructions or routing logic and may further use Artificial Intelligence (“AI”) techniques known to those skilled in the art including deep learning algorithms and incorporate data resources as listed in previous paragraph along with an array of other factors including but not limited to time-of-day, day-of-week, store hours, resource availability, service level requirements, previous customer interaction and transactions, customer tiering structure, data from 3^{rd} party systems including but not limited to CRM systems, location-based services, weather-services and so forth.

With a unique initiator ID for a product 120 or service 122 in place, an initiator 108, such as a QR code, may be generated. It is not necessary to always generate the initiator 108 with a dynamic-link communication platform 100. According to one embodiment, initiators 108 may also be received alongside the content and rules. Generated initiators 108 may be sent, forwarded, printed, mailed, or hosted on some form of media 110. Media 110 in this sense is referring to the many forms that an initiator may be placed. A non-exhaustive list includes printed materials such as billboards, posters, and flyers; and electronic means such as online advertisements, embedded advertisements, URLs, push notifications, streaming media, etc.

With the dynamic-link communication platform 100 initialized, a user 112 will observe 150 media 110 with an initiator 108, use his or her device—such as a mobile device 114—to engage 152 with an initiator 108, for example scanning a QR code, which will trigger the device 114 to auto-populate a text message 154. The user 112 will simply press the send key/button to send the message 156. In the case the initiator 108 is a QR code, then the destination of the message and other data may be embedded in the QR code such that the embedded data is then transferred along with the message to the dynamic-link communication platform 100 so that the dynamic-link communication platform 100 knows the context in which the message was sent. In almost every case there may be a way two derive context from a message. Take for example, three billboards all directed to the same product 120/campaign but each containing a different phone number, where the phone number is the initiator 108 and shares the same initiator ID. In this case a user will dial the phone number and be returned the content (e.g., a text message with the product information) and the number that was dialed gives context as to the location of the billboard and the user 112. In a case where the media 110 does not allow for context, but the initiator 108 has Internet access, the initiator 108 may communicate 176/178 with the management service component 104 of a dynamic-link communication platform 100 in order to provide context as well as deliver and confirm compliance with rules if applicable.

The message sent 156 from the device 114 is received by a message gateway 102 and forwarded 158 onto a management service 104. The message gateway 102 receives and sends messages from various modes of communication, e.g., text, email, voice, and other protocols. The initiator ID contained in the message is used to query 160 a data store 106 which will return 162 any content and rules associated with that initiator ID. Upon compliance with any rules, and if there is content to be delivered back to the device 114, then the content is sent 164 to the message gateway 102 for sending 166 back to the device 114. If the message was a request to communicate with an agent 118, then upon compliance with any rules, the message or content will be sent to the message gateway 102 for delivery 172 to the agent 118. The agent 118 if applicable, will send a return message 174, and that return message will again go to the management service 104 for rule compliance before being delivered to the device 114. Some content to be delivered to the device will contain external links 170 to the products 120 and services 122. Content, rules, and provided initiators 108 may be dynamically updated via communication lines 168 with the initiator targets 116. For example, if the URL to a product changes, the product owner may push updated content to replace the old content in the data store 106.

In some embodiments, platform 100 may store information associated with a user/mobile device history of interactions with platform 100 and/or various initiators 108 in a suitable database 106. For example, a record/profile may be established and associated with a mobile device (e.g., using a device identifier such as a mobile telephone number, Apple's IDFA for iOS devices, Google Advertiser ID for Android devices, International Mobile Equipment Identity, Media Access Control, etc.) comprising historical interaction data such as previous initiators the device/user has interacted with, metadata associated with each such interaction (e.g., time, location, device state, etc.), and outcomes associated with the interaction. In some aspects, outcomes associated with an interaction may comprise information related to: purchase history and whether or not the user made a purchase or subscribed to a service if the initiator is associated with a product or service; if a purchase/subscription was made for a different product/service than what was associated with the initiator, but was a result of the user being directed to the product via the initial deep link; user engagement with a product/service (e.g., how long the user stayed on the deep linked website/application); and user sentiment (which may be derived using natural language processing and/or understanding artificial intelligence systems and any subsequent messages/metadata exchanged between the user mobile device and platform 100). In some implementations, the content served to a mobile device 114 (e.g., via an auto populated message in a messaging application) responsive to the mobile device interacting with an initiator 108 may be based in part on such a record/profile and the information contained therein.

Customers/users and their devices 114, agents 118, 177 and their business user mobile device(s), other business user device(s), and TCPA compliant mobile device(s) used by agents 118, may connect to a dynamic-link communication platform 100, typically via a cellular phone network, although connections may be made through other means, as well, such as through the Internet via a Wi-Fi router for example. Similarly, devices may connect to over a Local Area Network (“LAN”) or Wide Area Network (“WAN”), the Internet, a direct physical connection to another device, or some other network connection. Dynamic-link communication platform system 100 may connect to 3^{rd} party or external systems or components, such as Customer Relationship Management (“CRM”) systems, Private Branch Exchange (“PBX”), traditional telephony call center agents, voicemail systems, and so forth, through 3rd party data gateway.

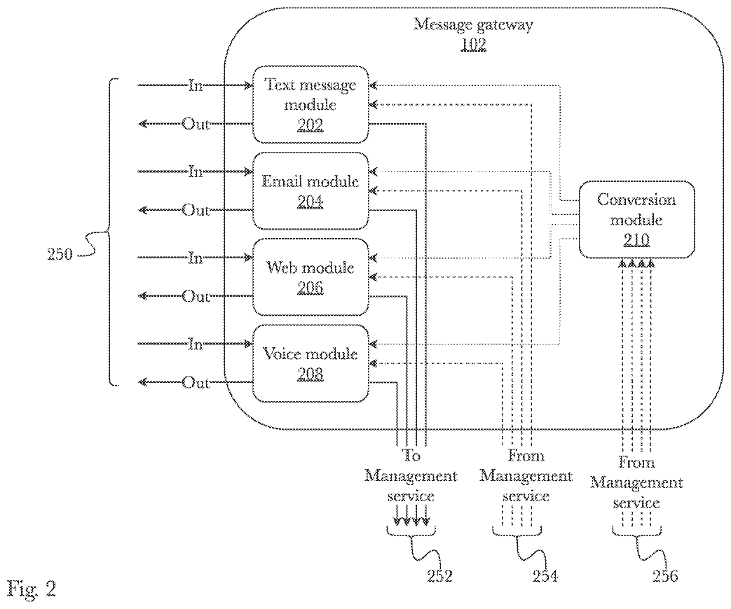

FIG. 2 is a block diagram illustrating an exemplary architecture for message gateway. The message gateway 102 may comprise various modules 202-208 which send and receive 250 different modes of communication. A conversion module 210 may be implemented which is dedicated to converting between different modes of communication. However, the arrangement of these modules and their inherent functions need not be arranged in the manner illustrated in FIG. 2. Another anticipated embodiment employs third-party gateway services where and if possible, such as an SMS-to-email gateway, however it may be more efficient to centrally perform the conversions, especially with regard to privacy.

Messages received 250 by the modules are sent to management service 252. The returned content or response messages from the management service may already be formatted in the proper format for the respective module 254. Returned content or response messages not properly formatted 256 may get formatted by the conversion module before going out to the proper module 202-208.

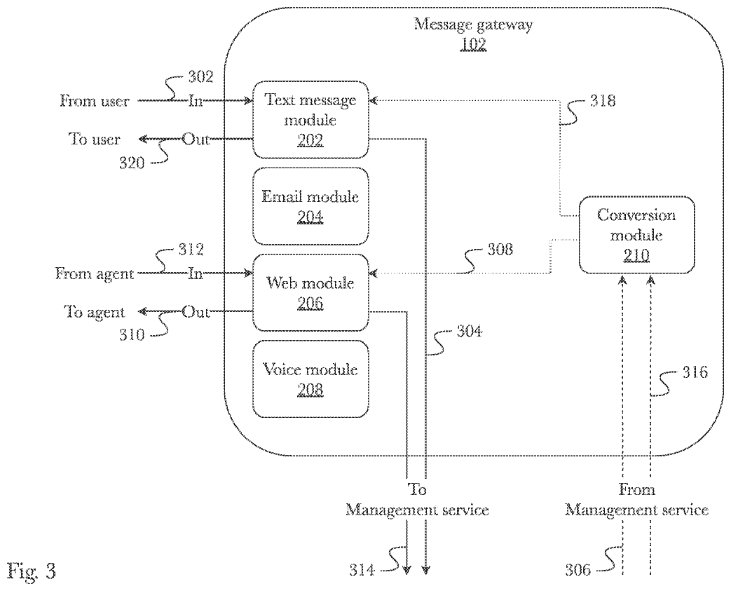

FIG. 3 is an example of a user engaging with an initiator that is intended to connect the user with a sales agent using a web-enabled chat interface. A user will interact with an initiator and then send the generated message which will be received 302 by a text message module 202. The text message module 202 may contain instructions to send and receive wireless protocols typically used for mobile devices such as SMS, MMS, iMessage, RCS, etc. The message is sent to the management service 304 where the initiator ID from the message will identify the campaign and subsequently at least one or more agents to query if they may respond to the request. The rules of the campaign may set forth what content the message to the agent contains. For example, the first message may just contain a query to approve or deny the request. According to another embodiment, the original message plus any metadata about the user or request may be slotted into an agent's queue. Many possibilities exist as to what the messages may contain and are not limited to the examples set forth herein. Irrespective of what the messages may contain, a message is sent to an agent 308/310 via the web module 206, however not before the text message is converted into the appropriate format 306 for the web module 206. The response from the agent 312 is sent to the management service for rule compliance 314 and then back 316 to the message gateway 102 conversion module 210 so that it may be converted into a text format to be set to the user 318/320.

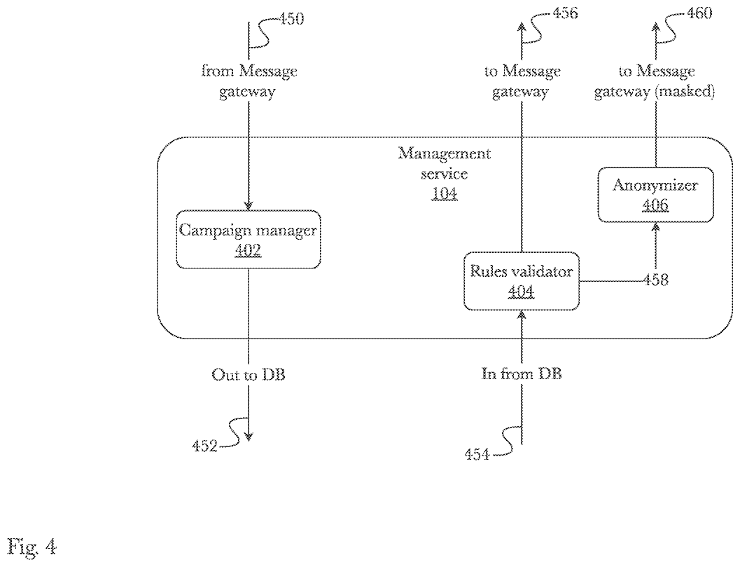

FIG. 4 is a block diagram illustrating an exemplary architecture for a management service 104. Messages from the message gateway are received 450 by the management service 104 and a campaign manager 402 uses the message initiator ID to retrieve the associated content and rules from one or more databases 452/454 and sends the rules to a rules validator 404. If there are no rules and only content to be served, then the content will simply be sent out to the message gateway 456. If a campaign from the one or more databases does contain one or more rules however, the rules validator 404 ensures that all the requirements of the campaign are met before sending the content or executing a specific action is performed. One example is that a rule may dictate that the message be stripped of private information before it is forwarded or used, and in such a case, the message will be sent to an anonymizer 406 before the message is sent 458 to the message gateway 460. The anonymizer 406 removes personally identifiable information (PII) from messages using machine learning algorithms such as natural language processing or natural language reasoning. Rules may go as far as being employed to prescreen the source of the message using the metadata embedded into the message as a way to discriminate whether or not the contents of the campaign may be allowed to be sent to the message sender.

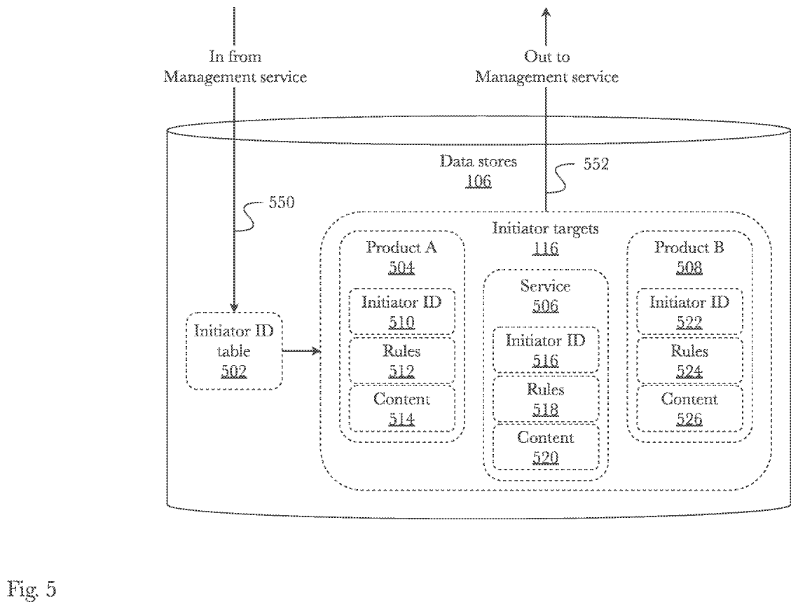

FIG. 5 is a block diagram illustrating exemplary data within one or more data stores 106. This diagram illustrates an exemplary logical representation of one way to organize and store data associated with an initiator in one or more data bases. In this arrangement an initiator ID table 502 stores a list of initiator IDs, each of which are linked with a memory address associated with each initiator target 116, i.e., campaign 504-508, in the data store. In this way, content and rules may be efficiently retrieved from the management service 550/552. According to this embodiment, each campaign 504-508 has at least their own set of rules 512/518/524, content 514/520/526, and an initiator ID 510/516/522.

Database(s) 106 may take the form of a managed or unmanaged database, document-oriented database system, or a Structured Query Language (“SQL”) database. Examples of types of database software that may operate include MYSQL™, ORACLE DATABASE™, MONGODB™, and others. It may exist as a distinct physical device or be operating on another computing device that may perform other functions aside from operating, hosting and serving the database 106. If it is a distinct physical device, the database may be connected over a LAN or WAN, the Internet, a direct physical connection to another device, or some other network connection.

FIG. 6 is a system diagram illustrating an RCS-based lead redirection and opt-in management system using phone-number-centric identity and verified messaging channels, with detailed sub-components for identity management, opt-in state management, channel eligibility determination, and personalization, according to an embodiment.

According to the embodiment, the system comprises user devices 610, which may include a laptop or desktop computer 611 and a mobile device 612 such as a smartphone or tablet, or other user devices as may become available in the future, if they are capable of communications with other networked devices. User devices 610 are configured to interact with digital activation assets 620 over a network 630 and are further configured to receive and display messages delivered via multiple messaging protocols, to transmit interaction signals and user responses to the system, and to execute user interactions including tapping, clicking, scanning, or otherwise using digital activation assets. User devices 610 may have varying communication capabilities including support for SMS, MMS, RCS, email, or web-based communication, and may provide device-identifying information such as phone numbers, email addresses, device identifiers, platform information, and messaging client capabilities that enable the system to establish user identity and determine appropriate communication protocols.

Digital activation assets 620 may comprise various trigger mechanisms including a call-to-action button 621, a redirect link 622, and a QR code 623, each of which may be embedded in advertisements, web pages, physical media, or messages to initiate user engagement with the system. Digital activation assets 620 are configured to be delivered to user devices 610 through multiple channels and formats, to encode campaign identifiers, product or service information, or opt-in context, and to generate interaction signals when accessed or activated by users. The digital activation assets 620 may be format-agnostic and capable of being delivered via email, SMS, MMS, RCS messages, web pages, or embedded within other digital content, with presentation and functionality adapting to the capabilities of the receiving user device 610 and the communication protocol used for delivery.

The network 630 may comprise one or more communication networks including the Internet, cellular networks, packet-switched data networks, or other network infrastructure capable of transmitting data between components of the system. Network 630 is configured to support bidirectional communication between user devices 610, messaging gateway 650, and interaction control server 640, to transmit messages using multiple protocols including SMS, MMS, RCS, email, and web-based communication, and to convey interaction signals, user responses, contextual metadata, device capabilities, and protocol information between system components.

User devices 610 communicate with an interaction control server 640 via network 630 and messaging gateway 650, wherein the interaction control server 640 operates to manage opt-in events, determine messaging channel eligibility, coordinate session state, and control lead redirection operations as described in various embodiments herein. According to the embodiment, the interaction control server 640 comprises multiple sub-components or integrated services that collectively provide identity management, opt-in state management, channel eligibility determination, and personalization capabilities.

The interaction control server 640 comprises an identity management service 641, which is configured to maintain persistent user identity profiles anchored to phone numbers as primary identifiers, to store and manage identity records comprising interaction history, device associations, communication preferences, opt-in records, engagement patterns, and accumulated contextual observations, to resolve user identity from phone numbers, email addresses, device identifiers, or other identifying information received during interactions, to merge new contextual data with existing identity profiles upon each user interaction, to enrich identity profiles with inferred preferences and behavioral patterns derived from accumulated data, and to provide identity data to other components of the interaction control server 640 and to downstream lead destinations 660 subject to opt-in scope and privacy constraints. The identity management service 641 treats phone numbers as identity DNA, creating a stable anchor for persistent user identification across devices, channels, sessions, and time periods, enabling the accumulation of contextual intelligence that compounds with each interaction.

The interaction control server 640 further comprises an opt-in state manager 642, which is configured to capture and record opt-in events triggered by user interactions with digital activation assets 620, to maintain opt-in state information using a state-based model rather than binary permission flags, to associate opt-in events with contextual metadata including activation asset identifiers, campaign parameters, timestamps, device characteristics, and consent scope parameters, to manage multiple opt-in states indicating different levels or types of messaging eligibility including no opt-in, basic messaging permission, enhanced messaging capability permission, and verified or branded messaging context permission, to enforce state transitions in response to user actions, elapsed time, campaign context changes, or external verification processes, to consult opt-in state when determining whether messages may be sent and which messaging protocols and features may be enabled, to log and retain opt-in events and state transitions for audit, reporting, and compliance purposes, and to provide opt-in state information to channel eligibility service 643 and other components for use in downstream processing decisions.

The interaction control server 640 further comprises a channel eligibility service 643, which is configured to determine which messaging channels and protocols are eligible for use in a given interaction based on evaluation of opt-in state from opt-in state manager 642, device capabilities, carrier enablement, platform support, business verification status, and campaign configuration, to evaluate channel eligibility as a distinct processing step occurring after opt-in capture and prior to message delivery, to conditionally enable enhanced messaging capabilities including RCS only when eligibility criteria are satisfied, to apply prioritization rules when multiple channels are eligible to select a preferred protocol based on feature richness, expected user experience, reliability, or prior interaction history, to dynamically reevaluate eligibility over time or across interaction steps in response to user actions, changes in device or platform configuration, completion of verification processes, or elapsed time, to communicate with RCS platform interface 651 to negotiate and retrieve RCS capability information, to maintain capability cache storing previously retrieved capability profiles associated with devices, users, or messaging identifiers, to select fallback messaging protocols when enhanced capabilities are unavailable while preserving interaction continuity and attribution, and to provide channel and protocol selection decisions to messaging gateway 650 for message delivery.

The interaction control server 640 further comprises a personalization and inference manager 644, which is configured to apply inference logic and machine learning algorithms to accumulated identity data to derive implicit user preferences without requiring explicit confirmation, to analyze interaction patterns across time to infer preferred communication times, preferred devices, preferred protocols, and product or service interests, to generate behavioral models predicting user engagement propensity and responsiveness, to continuously refine understanding of user preferences and behavior patterns with each new interaction using phone number as stable identity anchor, to create compounding intelligence that improves personalization and targeting effectiveness over time, to determine optimal future contact strategies including protocol selection, timing, device targeting, and message personalization based on accumulated intelligence, to provide personalization recommendations to channel eligibility service 643 and identity management service 641 for use in message preparation and delivery, to generate enriched user context for transmission to downstream lead destinations 660, and to enable progressively improving engagement experiences with reduced friction as the system accumulates more data about each user identity. The personalization and inference manager 644 may utilize artificial intelligence, machine learning, natural language processing, behavioral analytics, or other computational intelligence techniques to extract insights from accumulated interaction data and to optimize engagement strategies dynamically.

Interaction control server 640 is further configured to receive and process digital activation asset interactions forwarded from messaging gateway 650, to determine user identity and communication preferences using contextual data including device type, platform information, messaging protocol used, and historical interaction patterns by coordinating between identity management service 641, opt-in state manager 642, channel eligibility service 643, and personalization and inference manager 644, to maintain persistent user identity profiles associated with phone numbers or other identifiers, to accumulate and update contextual information about users over time without requiring repeated explicit confirmation, to select appropriate messaging protocols and communication methods for future interactions based on accumulated context and implicit preferences, to generate and format data for transmission to downstream lead destinations 660 using preferred or preconfigured formatting or data transmission methods such as proprietary APIs or generalized JSON objects, and to enable frictionless future communications by automatically routing messages over preferred communication media and protocols to preferred devices using all available context.

A messaging gateway 650 is communicatively coupled to both the interaction control server 640 and the network 630. The messaging gateway 650 may be communicatively coupled to the interaction control server 640 through various architectural configurations, including: as a directly coupled component wherein messaging gateway 650 and interaction control server 640 are integrated within the same computing system or physically co-located hardware; as a sub-component wherein messaging gateway 650 operates as a functional software application or service, or physical device such as an ASIC or specialized chip, within interaction control server 640, or vice versa; through direct on-premises connection wherein messaging gateway 650 and interaction control server 640 are separate physical devices connected via local area network, direct physical connection, or other on-premises infrastructure; or through network-based connection wherein messaging gateway 650 and interaction control server 640 are decoupled and communicate over one or more networks 630 including the Internet, wide area networks, or other remote communication infrastructure. Regardless of the specific coupling architecture employed, messaging gateway 650 and interaction control server 640 are configured to exchange data bidirectionally to coordinate messaging operations, channel selection, and interaction processing.

The messaging gateway 650 comprises an RCS platform interface 651, which is configured to communicate with external RCS platform services, carrier RCS networks, and RCS business messaging providers, to negotiate RCS capabilities for specific phone numbers or devices by querying capability endpoints or retrieving capability information from platform services, to retrieve capability profiles indicating supported RCS features including rich cards, interactive buttons, suggested replies, rich media, branded sender identity, persistent sessions, and any feature limitations or restrictions, to verify business sender status and retrieve verified identity information including registered business names, brand logos, and verification badges, to transmit RCS messages with appropriate formatting, branding, and interactive elements based on negotiated capabilities, to receive RCS message delivery confirmations, read receipts, and user interaction events, to detect RCS delivery failures or capability unavailability conditions, and to provide capability information and delivery status to channel eligibility service 643 within interaction control server 640 for use in eligibility determination and fallback decisions. The RCS platform interface 651 enables the messaging gateway 650 to leverage enhanced RCS features when available while maintaining robust fallback capabilities when RCS is unsupported or unavailable.

Messaging gateway 650 is configured to support multiple messaging protocols including Rich Communication Services (RCS), Short Message Service (SMS), and Multimedia Messaging Service (MMS), and operates to transmit messages to user devices 610 and receive inbound user responses based on channel eligibility determinations and capability negotiations performed by interaction control server 640 through coordination between channel eligibility service 643 and RCS platform interface 651. Messaging gateway 650 is further configured to receive digital activation assets from interaction control server 640 for delivery to users, to determine messaging protocol and methodology to use for each user based on user signup contact information and device capabilities in coordination with channel eligibility service 643, to deliver digital activation assets to user devices 610 in formats appropriate to the selected protocol and receiving device, to receive digital activation asset interactions from user devices 610 including URL accesses from referral links, data from QR code scans, button presses, or other user-initiated actions, to capture and forward interaction events along with contextual metadata to interaction control server 640, to transmit comprehensive contextual data including the interaction content, messaging protocol used, device type, platform information, carrier network, geographic or network location data, timestamp information, and any other available contextual metadata, to receive inbound user interactions and responses during ongoing communications, and to route such interactions back to interaction control server 640 with all available context for processing by identity management service 641, opt-in state manager 642, and personalization and inference manager 644, and for potential forwarding to downstream lead destinations 660.

The system further comprises downstream lead destinations 660, which may include a customer relationship management system 661, a call center 662, a sales agent 663, an external API 664, and a loyalty management system 665. Downstream lead destinations 660 are configured to receive redirected leads and interaction context from interaction control server 640, enabling businesses to respond to user engagement with products or services.

The loyalty management system 665 is configured to manage loyalty programs, reward points, incentive structures, and customer engagement benefits associated with user identities maintained by identity management service 641, to track user engagement activities and assign loyalty value or points based on interactions, purchases, or other qualifying behaviors, to provide loyalty status information and available rewards to interaction control server 640 for use in message personalization and user engagement strategies, to deliver loyalty benefits including discounts, exclusive offers, or reward redemptions through messaging channels coordinated by messaging gateway 650 and interaction control server 640 without requiring users to install dedicated loyalty applications, to integrate loyalty wallet functionality directly into messaging interactions by presenting loyalty information, available rewards, and redemption options within RCS messages or other message formats when capabilities permit, to receive loyalty-relevant user actions and transactions from interaction control server 640 for loyalty account updates and reward calculations, and to enable phone-number-anchored loyalty identification wherein users are recognized and rewarded based on their phone number identity without requiring separate loyalty account credentials or application installations. The loyalty management system 665 enables persistent loyalty engagement tied to phone number identity, creating switching costs and ongoing value that compounds over time alongside the identity and preference data accumulated by identity management service 641 and personalization and inference manager 644.

Downstream lead destinations 660 are further configured to receive formatted data or requests for further user contact from interaction control server 640, wherein the received data comprises user identity information from identity management service 641, interaction context, campaign identifiers, product or service information, communication preference data derived from personalization and inference manager 644, opt-in state from opt-in state manager 642, consent information, enriched behavioral insights, and loyalty status from loyalty management system 665, to receive data about the context and identity and implicit preferences of users based on their interactions, to receive such data in formats tailored to each destination's technical capabilities using preferred or preconfigured formatting or data transmission methods such as proprietary APIs or generalized JSON objects, to save and store information on how to interact with users for future communications including preferred communication protocols, contact information, interaction history, product interests, campaign context, and opt-in state information, to access and utilize accumulated user context and preference information for ongoing relationship management and follow-up interactions, and to conduct future communications with users through messaging gateway 650 and interaction control server 640 rather than establishing direct communication channels, thereby allowing the system to preserve privacy protections by masking direct contact information between users and business resources, maintain session continuity and attribution across multiple interaction points and time periods, enable ongoing updates to user context and identity over time through identity management service 641 and personalization and inference manager 644, and ensure that all communications remain subject to opt-in state and channel eligibility determinations managed by opt-in state manager 642 and channel eligibility service 643.

The interaction control server 640 may route user interactions to one or more of the downstream lead destinations 660 based on campaign configuration, user responses, routing logic executed by channel eligibility service 643 or other routing components, availability of destination resources, user identity attributes from identity management service 641, engagement predictions from personalization and inference manager 644, or loyalty status from loyalty management system 665, while preserving session continuity, attribution data, and privacy protections across the engagement lifecycle. The routing may be performed using conditional logic that considers campaign or activation asset associations, content or type of user responses, current messaging channel and capability state, session history or interaction sequence, business rules or configuration parameters, and personalized routing strategies optimized for each user identity.

In operation, the interaction control server 640 may first establish a preferred or default communication protocol based on user device type, wherein device-identifying information such as email address, phone number, or other identifiers indicates the basic device type or communication methods available to the user. The interaction control server 640, through coordination between identity management service 641 and channel eligibility service 643, then sends out digital activation asset(s) to messaging gateway 650, which determines the messaging protocol and methodology to use for the user based on user signup contact information through consultation with channel eligibility service 643 and RCS platform interface 651, assessing device capabilities, carrier support, and platform constraints to select an appropriate channel such as email, SMS, MMS, or RCS. Digital activation assets 620 are received by user device(s) 610 in a format appropriate for the receiving device and communication channel, such as a QR code received by email address, a redirect link sent via SMS message, or a call-to-action button embedded in an RCS message delivered through RCS platform interface 651. A user may interact with one of the digital activation assets 620 using a user device 610 by tapping, clicking, scanning, or otherwise using the digital activation asset, which generates an interaction signal that is sent to messaging gateway 650 over network 630.

Messaging gateway 650 receives the digital activation asset interaction and forwards the digital asset activation/interaction and context data, including communication protocol(s) used, device type, platform information, and other available metadata, to interaction control server 640. The interaction control server 640 processes the received interaction using identity management service 641 to determine user identity and communication preferences using contextual data, which may involve matching the interaction to an existing user profile based on phone number, email address, device identifier, or other identifying information, creating a new identity profile if none exists with phone number as the persistent identity anchor, and inferring communication preferences from the protocol used, stored user profile data, or prior interaction history. The opt-in state manager 642 records an opt-in event triggered by the interaction, capturing contextual metadata and establishing or updating opt-in state information that governs subsequent messaging eligibility.

Based on the opt-in state from opt-in state manager 642, device capabilities negotiated through RCS platform interface 651, carrier support information, and verification status, the channel eligibility service 643 within interaction control server 640 determines whether RCS messaging is eligible for the interaction, consulting capability profiles and applying eligibility rules. If RCS is eligible, channel eligibility service 643 instructs messaging gateway 650 to deliver an RCS message through RCS platform interface 651 with enhanced features such as branded sender identity, rich card layout, or interactive buttons. If RCS is not eligible, channel eligibility service 643 selects an alternative protocol such as SMS or MMS while preserving interaction intent. The personalization and inference manager 644 may influence message content, timing, and presentation based on accumulated intelligence about the user identity to optimize engagement likelihood.

The interaction control server 640 sends formatted data or requests for further user contact to downstream lead destinations 660, which may include user identity information from identity management service 641, interaction context, campaign identifiers, communication preference data from personalization and inference manager 644, opt-in state information from opt-in state manager 642, and loyalty status from loyalty management system 665. Downstream lead destinations 660 save information on how to interact with the user for future communications, storing preferred communication protocols, contact information, interaction history, and consent information in customer relationship management system 661 or other data repositories.

User responses or interactions with delivered messages are received by messaging gateway 650, which sends data to interaction control server 640 comprising the interaction and all context available to the message, including protocol, device type, platform, carrier network, timestamp, and other contextual metadata. The identity management service 641 associates the response with the user's identity profile and updates accumulated contextual data. The personalization and inference manager 644 processes the new interaction data to refine behavioral models and preference predictions. The interaction control server 640 sends data about the context and identity and implicit preferences of the user based on the interaction to downstream lead destinations 660 using preferred or preconfigured formatting or data transmission methods such as proprietary APIs or generalized JSON objects.

User contact via downstream lead destinations 660 continues to go through messaging gateway 650 and interaction control server 640, allowing for updates to user context and identity over time through continuous operation of identity management service 641 and personalization and inference manager 644. Future communications with users are done over preferred communication medium and protocol determined by channel eligibility service 643 based on accumulated preference data from personalization and inference manager 644, to preferred device identified through device association tracking in identity management service 641, using all available context without asking the user to directly confirm information, thereby enabling frictionless continuation of interactions across sessions and time periods while respecting established identity managed by identity management service 641, preferences inferred by personalization and inference manager 644, and opt-in state maintained by opt-in state manager 642. Such user responses or interactions with delivered messages may trigger lead redirection actions, causing interaction control server 640 to route the engagement to one or more downstream lead destinations 660, potentially including loyalty management system 665 for loyalty program updates, while maintaining interaction context and attribution information throughout the engagement lifecycle through coordinated operation of all sub-components within interaction control server 640.

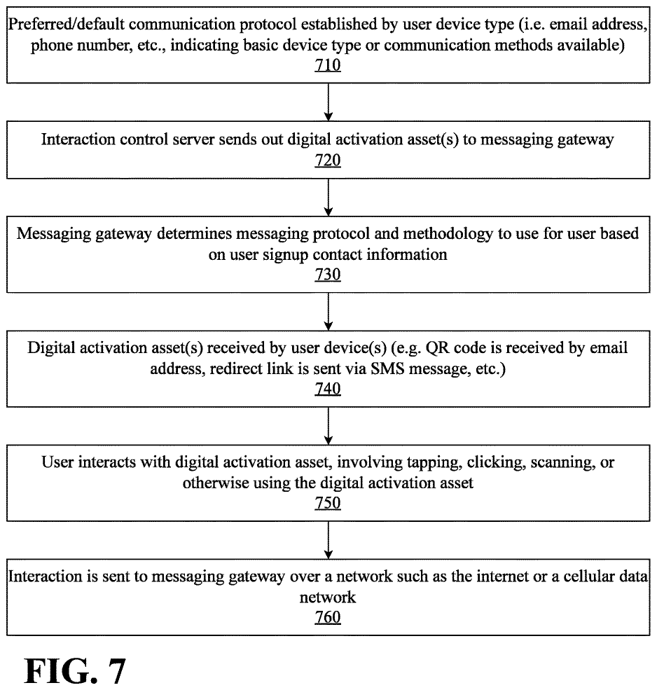

FIG. 7 is a method diagram illustrating steps for delivering digital activation assets to users and capturing user interaction with such assets to initiate opt-in and engagement flows, according to an embodiment.

At step 710, a preferred or default communication protocol is established by user device type. The communication protocol determination may be based on identifiers such as email address, phone number, or other device-identifying information, which indicates the basic device type or communication methods available to the user. For example, the presence of a phone number may indicate a mobile device capable of SMS or RCS messaging, while an email address may indicate a desktop or laptop computer, or may be used as an alternative contact method for mobile devices. This determination allows the system to tailor the delivery method and format of digital activation assets to the capabilities and preferences of the user's device.

At step 720, the interaction control server sends out digital activation asset(s) to a messaging gateway. The digital activation assets may comprise call-to-action buttons, redirect links, QR codes, or other interactive elements designed to initiate user engagement with a product, service, or marketing campaign. The interaction control server may generate or retrieve the digital activation assets based on campaign configuration, user profile data, or targeting parameters, and may include metadata associating the assets with specific campaigns, products, or opt-in contexts.

At step 730, the messaging gateway determines the messaging protocol and methodology to use for the user based on user signup contact information. This determination may involve evaluating the contact information provided at step 710, assessing device capabilities, carrier support, and platform constraints, and selecting an appropriate messaging channel such as email, SMS, MMS, or RCS. The messaging gateway may apply protocol selection logic that prioritizes richer communication channels when available while ensuring reliable delivery through fallback mechanisms when enhanced capabilities are not supported.

At step 740, digital activation asset(s) are received by user device(s). The manner in which the assets are received depends on the messaging protocol and methodology selected at step 730. For example, a QR code may be received by email address and displayed to the user, a redirect link may be sent via SMS message, or a call-to-action button may be embedded in an RCS message or web page. The digital activation assets are presented to the user in a format appropriate for the receiving device and communication channel.

At step 750, the user interacts with the digital activation asset. User interaction may involve tapping, clicking, scanning, or otherwise using the digital activation asset to signal interest in the associated product, service, or campaign. Such interaction constitutes an initial trigger that initiates the opt-in capture and lead redirection processes described in various embodiments herein. The interaction may be performed using a touchscreen interface, mouse click, camera-based QR code scanner, or other input mechanism available on the user device.

At step 760, the interaction is sent to the messaging gateway over a network such as the internet or a cellular data network. The interaction may be transmitted as a message, API call, HTTP request, or other data transmission appropriate to the communication protocol in use. The messaging gateway receives the interaction signal and may forward it to the interaction control server for processing, opt-in recording, channel eligibility determination, and subsequent messaging or lead redirection actions as described in other figures and embodiments of the present disclosure.

FIG. 8 is a method diagram illustrating steps for phone-number-centric identity establishment, persistent tracking, and contextual enrichment over time, according to an embodiment. This method demonstrates how the system treats phone numbers as stable identity anchors that enable accumulation of contextual intelligence, inference of implicit user preferences, and progressive improvement of engagement strategies without requiring repeated explicit user confirmation.

An initial interaction is received with phone number and contextual data comprising device, platform, source, timestamp, and campaign 801. The interaction control server receives user engagement data triggered by interaction with a digital activation asset, inbound message, or other user-initiated contact as described in other figures herein. The received data comprises a phone number that serves as the primary user identifier, along with rich contextual metadata that provides insight into the interaction circumstances. The contextual data may include device type information such as smartphone model, operating system, or browser type, platform information indicating the messaging service, carrier network, or application through which contact was initiated, source information identifying the specific activation asset, campaign, advertisement, or referral that prompted the interaction, timestamp data recording the precise date and time of the interaction, campaign identifiers linking the interaction to specific marketing initiatives or product promotions, and any additional metadata available from the interaction channel. This comprehensive contextual data provides the foundation for building and enriching a persistent user identity profile.

The identity database is queried using the phone number as primary key 802. The identity management service 641 within the interaction control server, as illustrated in FIG. 6, performs a lookup operation in the identity database using the phone number received in the initial interaction as the search key. The phone number serves as the primary identifier or “identity DNA” that anchors all user data, interaction history, and accumulated intelligence. The database query seeks to determine whether a pre-existing identity profile is associated with this phone number from prior interactions, or whether this represents a first-time engagement requiring creation of a new identity record. The use of phone number as the primary key enables persistent identity tracking across devices, channels, sessions, and time periods, as phone numbers remain stable identifiers even when users change devices, upgrade operating systems, or interact through different applications or messaging platforms.

If no profile exists, a new identity record is created with phone number as persistent identifier; if exists, accumulated data is retrieved 803. The identity management service 641 executes conditional logic based on the database query results. If no existing identity profile is found, the system initializes a new identity record in the identity database, establishing the phone number as the permanent anchor for this user's identity and storing the contextual data from the initial interaction as the first data points in what will become an accumulating intelligence profile. If an existing identity profile is found, the system retrieves the complete accumulated data set associated with this phone number, which may include interaction history spanning multiple prior engagements, device associations identifying phones, tablets, or computers previously used by this user, communication preferences indicating preferred protocols, channels, or contact times, opt-in records documenting consent state and scope, engagement patterns showing response rates, interaction frequency, and behavior trends, product or service interests inferred from prior campaigns or purchases, demographic or behavioral attributes derived from interaction patterns, and any other contextual observations or enrichment data accumulated over the user's relationship with the system. This retrieval makes the full historical context available for processing the current interaction.

New contextual data is merged with the profile: device associations updated, preferences enriched, interaction recorded, engagement metrics updated 804. The identity management service 641 integrates the new interaction data received in the current engagement with the existing identity profile retrieved from the database. The merge operation updates device associations by adding any new device identifiers to the user's profile or updating timestamps for previously seen devices, enriches communication preferences by incorporating signals from the current interaction such as the protocol used, time of day, or response patterns, records the complete current interaction event in chronological interaction history with all associated metadata, updates engagement metrics including interaction frequency, recency of last engagement, response rates to prior messages, and overall engagement score or propensity indicators, and incorporates any campaign-specific data that provides insight into user interests or purchase intent. This merging process ensures that each interaction contributes to an ever-growing understanding of the user, with the phone number serving as the stable anchor that enables data accumulation across time and channels. The system maintains continuity even when users interact from different devices or through different messaging platforms, as all interactions sharing the same phone number are attributed to the same persistent identity.

Inference logic is applied to derive implicit preferences: communication times, preferred devices/protocols, and product interests 805. The personalization and inference manager 644 within the interaction control server, as illustrated in FIG. 6, analyzes the accumulated and newly merged identity data to extract higher-level insights about user preferences without requiring explicit user confirmation or survey responses. The inference algorithms may employ statistical analysis, pattern recognition, machine learning models, or behavioral analytics to identify trends and preferences from the raw interaction data. The derived preferences may include optimal communication times determined by analyzing timestamps of prior successful interactions to identify when the user is most responsive, preferred devices identified by detecting patterns of device usage across different contexts or times of day, preferred protocols or messaging channels inferred from user selection patterns or engagement rates across different communication methods, product or service interests derived from the types of campaigns or activation assets with which the user has engaged, content preferences indicated by interaction depth or response patterns to different message formats, and behavioral propensities such as likelihood to respond quickly, preference for concise versus detailed information, or sensitivity to promotional frequency. These inferred preferences enable the system to optimize future interactions for each individual user based on observed behavior rather than requiring users to explicitly configure preferences or answer preference questions.

Derived preferences are stored persistently, creating compounding intelligence improving with each interaction 806. The identity management service 641 records the inferred preferences generated by the inference logic back into the persistent identity profile associated with the user's phone number. These derived insights become part of the accumulating intelligence that compounds over time, with each new interaction providing additional data points that refine and improve the accuracy of preference predictions. The compounding nature of this intelligence creates increasing value from the persistent phone-number-anchored identity, as users who have engaged multiple times benefit from progressively more accurate personalization and optimized interaction strategies. The stored preferences include confidence scores or weights that reflect the strength of evidence supporting each inference, timestamps indicating when each preference was last updated or confirmed, and versioning information that enables the system to track how user preferences evolve over time. This persistent storage ensures that intelligence gained from one interaction is preserved and applied to all future interactions with the same phone number identity.

Identity enrichment updates communication strategy: optimal protocol, timing, and device determined automatically 807. The channel eligibility service 643 and personalization and inference manager 644 within the interaction control server utilize the enriched identity data and derived preferences to automatically optimize the communication strategy for future interactions with this user. The system determines the optimal messaging protocol by referencing the user's inferred protocol preferences, device capabilities, and engagement history to select among RCS, SMS, MMS, email, or other available channels without requiring the user to explicitly specify a preference. The optimal timing for future communications is determined by analyzing the user's historical response patterns and interaction timestamps to identify when the user is most likely to be receptive to messages. The preferred device is identified based on device association patterns and usage contexts, enabling the system to route messages to the device the user is most likely to be monitoring at a given time. These strategy determinations occur automatically based on accumulated intelligence, eliminating the need for users to configure communication preferences explicitly or to respond to preference surveys. The automatic optimization improves user experience by delivering messages through channels and at times that match observed user behavior patterns.

Enriched identity data is transmitted to downstream destinations subject to opt-in scope and privacy constraints 808. The interaction control server formats and transmits relevant portions of the enriched identity profile to downstream lead destinations 660 as illustrated in FIG. 6, which may include customer relationship management system 661, call center 662, sales agent 663, external API 664, or loyalty management system 665. The transmitted data enables downstream systems to leverage the accumulated intelligence for personalized follow-up, relationship management, and targeted engagement. The data transmission is governed by the opt-in scope maintained by opt-in state manager 642 and subject to privacy constraints and authorization controls that limit which data elements may be shared with which downstream systems. The transmitted information may include user identity and contact information, communication preferences and optimal engagement strategies, product interests and behavioral propensities, interaction history and engagement metrics, loyalty status or customer value indicators, and any other contextual intelligence relevant to the specific downstream destination's function. The transmission may utilize proprietary APIs, generalized JSON objects, or other data formats as configured for each downstream system, enabling integration with diverse business systems while maintaining centralized control over identity data and privacy protections.

Subsequent interactions auto-apply accumulated intelligence, enabling frictionless engagement with progressive personalization 809. When the same phone number initiates contact in future interactions, the interaction control server automatically retrieves the enriched identity profile and applies all accumulated intelligence without requiring the user to re-provide information, re-confirm preferences, or repeat prior interactions. The system recognizes the user immediately based on phone number, selects optimal communication protocols and channels based on inferred preferences, personalizes message content and timing based on behavioral insights, routes interactions to appropriate downstream destinations based on interaction history and current context, and adapts the engagement strategy dynamically as new data continues to accumulate. This automatic application of accumulated intelligence creates a progressively improving user experience where each interaction builds on prior engagements, friction decreases over time as the system learns more about each user, and personalization becomes increasingly accurate without requiring explicit user effort. The frictionless continuation of engagement across sessions and time periods differentiates this phone-number-centric identity approach from systems that treat each interaction as an isolated event or that require repeated user authentication and preference specification.

The identity profile continues compounding over time with phone number as stable anchor across all interactions 810. The persistent nature of phone numbers as user identifiers enables unlimited accumulation of contextual intelligence over the entire lifetime of the user's relationship with the system. Unlike cookie-based identifiers that expire, device identifiers that change when users upgrade hardware, or email addresses that users may abandon, phone numbers tend to remain stable over extended periods, providing a durable anchor for long-term identity continuity. As months or years pass and the user engages in dozens or hundreds of interactions, the identity profile associated with their phone number continues to grow richer and more accurate. The compounding intelligence effect means that the value of the identity data increases non-linearly over time, as more data points enable more sophisticated inferences, better predictions, and more effective personalization. The system may apply decay functions to older data points to ensure that recent behavior patterns are weighted more heavily than distant historical data, allowing the identity profile to adapt as user preferences evolve while still benefiting from long-term behavioral insights. This continuous compounding of intelligence tied to the stable phone number anchor creates substantial switching costs for users and competitive advantages for businesses, as the accumulated knowledge and resulting personalized experience cannot be easily replicated by alternative systems that lack the same depth of identity-anchored historical data.

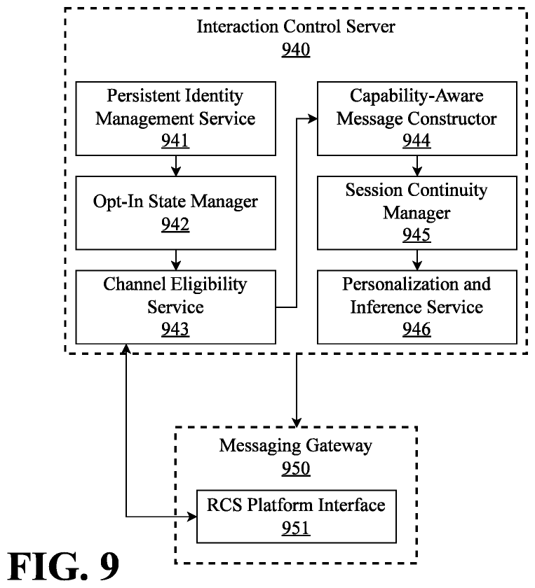

FIG. 9 is a system diagram illustrating an enhanced interaction control server architecture with six-service addition, according to an embodiment. According to the embodiment, the system comprises an interaction control server 940 containing six integrated services that provide persistent identity management, multi-state opt-in tracking, channel eligibility determination, capability-aware message construction, session continuity management, and personalization capabilities.

The interaction control server 940 comprises a persistent identity management service 941, which is configured to maintain phone-number-anchored identity profiles that persist across devices, messaging protocols, campaigns, and time periods. The persistent identity management service 941 stores and manages identity records comprising interaction history, device associations, communication preferences, opt-in records, engagement patterns, and accumulated contextual observations, and provides identity data to other services within the interaction control server 940 and to downstream lead destinations subject to opt-in scope and privacy constraints.

The interaction control server 940 further comprises an opt-in state manager 942, which is configured to capture and record opt-in events triggered by user interactions with digital activation assets, to maintain opt-in state information using a multi-state consent model rather than binary permission flags, and to associate opt-in events with contextual metadata including activation asset identifiers, campaign parameters, timestamps, device characteristics, and consent scope parameters. The opt-in state manager 942 manages multiple opt-in states indicating different levels of messaging eligibility including no opt-in, basic messaging permission, enhanced messaging capability permission, and verified or branded messaging context permission, and enforces state transitions in response to user actions, elapsed time, campaign context changes, or external verification processes.

The interaction control server 940 further comprises a channel eligibility service 943, which is configured to determine which messaging channels and protocols are eligible for use in a given interaction based on evaluation of opt-in state from the opt-in state manager 942, device capabilities, carrier enablement, platform support, business verification status, and campaign configuration. The channel eligibility service 943 evaluates channel eligibility as a distinct processing step occurring after opt-in capture and prior to message delivery, conditionally enables enhanced messaging capabilities including RCS only when eligibility criteria are satisfied, and communicates with RCS platform interface 951 within messaging gateway 950 to negotiate and retrieve RCS capability information.

The interaction control server 940 further comprises a capability-aware message constructor 944, which is configured to format messages based on selected protocol and capabilities determined by the channel eligibility service 943, to adapt rich features such as cards, buttons, and media to protocol constraints, to reconstruct interaction intent for fallback protocols when enhanced capabilities are unavailable, and to preserve core interaction logic across all message formats. The interaction control server 940 further comprises a session continuity manager 945, which is configured to assign and maintain session identifiers across interactions, to handle delivery failures and trigger protocol transitions, to preserve conversation context and attribution across channel changes, and to match user responses to sessions despite protocol variations. The interaction control server 940 further comprises a personalization and inference service 946, which is configured to apply inference logic and machine learning algorithms to accumulated identity data to derive implicit user preferences without requiring explicit confirmation, to analyze interaction patterns across time to infer preferred communication times, preferred devices, preferred protocols, and product or service interests, and to continuously refine understanding of user preferences and behavior patterns with each new interaction.

The messaging gateway 950 is communicatively coupled to the interaction control server 940 and comprises an RCS platform interface 951, which is configured to communicate with external RCS platform services, carrier RCS networks, and RCS business messaging providers, to negotiate RCS capabilities for specific phone numbers or devices by querying capability endpoints, and to transmit RCS messages with appropriate formatting, branding, and interactive elements based on negotiated capabilities. The messaging gateway 950 is further configured to support multiple messaging protocols including SMS and MMS in addition to RCS, to receive delivery instructions from the interaction control server 940, and to deliver messages to user devices using the selected messaging protocol as determined by the channel eligibility service 943.

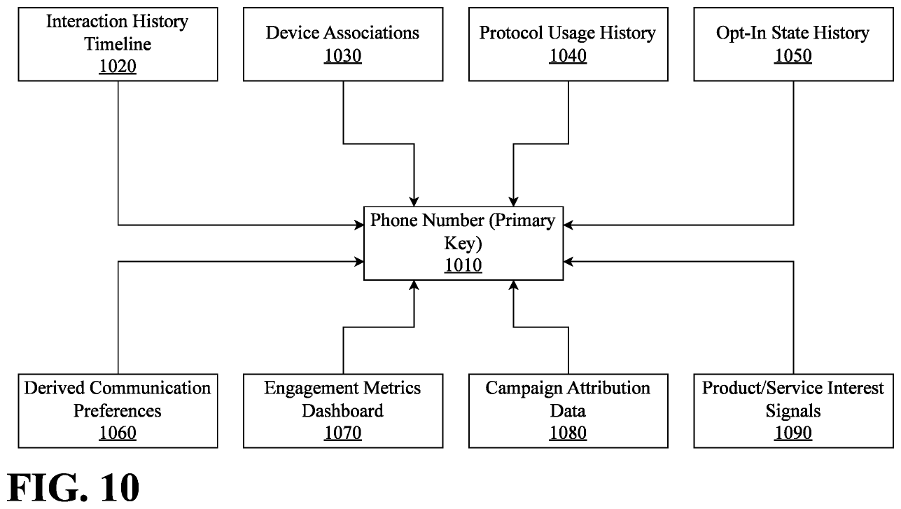

FIG. 10 is a block diagram illustrating a persistent identity profile data structure, according to an embodiment. The diagram shows the constituent elements of an identity record that is maintained by the persistent identity management service and anchored to a phone number as a stable identifier across devices, protocols, campaigns, and time periods.

At the center of the identity profile structure is a phone number 1010, which functions as the primary key and identity anchor. The phone number 1010 serves as a persistent identifier that remains stable across user interactions regardless of device changes, messaging protocol variations, or campaign contexts, enabling the system to accumulate and retrieve contextual intelligence associated with a single user identity over extended time periods.

The identity profile comprises an interaction history timeline 1020, which stores a chronological record of all interactions between the user and the system including message exchanges, activation asset engagements, protocol usage, and response patterns. The identity profile further comprises device associations 1030, which track multiple devices that have been linked to the phone number identity, enabling the system to recognize and optimize communications across different user devices. The identity profile further comprises protocol usage history 1040, which records which messaging protocols have been successfully used for communications with this identity, including information about RCS capability, SMS/MMS usage, and protocol transition events. The identity profile further comprises opt-in state history 1050, which maintains a temporal record of consent state transitions, capturing when opt-in events occurred, what consent scope was granted, which activation assets triggered opt-in, and how consent status has evolved over time.

The identity profile further comprises derived communication preferences 1060, which store inferred preferences about optimal communication timing, preferred protocols, preferred devices, and engagement patterns as determined through analysis of accumulated interaction data without requiring explicit user confirmation. The identity profile further comprises engagement metrics dashboard 1070, which tracks quantitative measures of user engagement including response rates, interaction frequency, message open rates, conversion events, and other behavioral indicators. The identity profile further comprises campaign attribution data 1080, which associates interactions and outcomes with specific marketing campaigns, activation assets, and promotional initiatives to enable performance measurement and optimization. The identity profile further comprises product or service interest signals 1090, which accumulate indications of user interest in particular products, services, categories, or features based on interaction patterns, activation asset engagements, and behavioral analysis.

Together, these data elements comprise a comprehensive identity profile that compounds in intelligence and richness with each new interaction, enabling progressively improving personalization and communication optimization over time while maintaining the phone number 1010 as the stable anchor that ties all accumulated data to a persistent user identity.

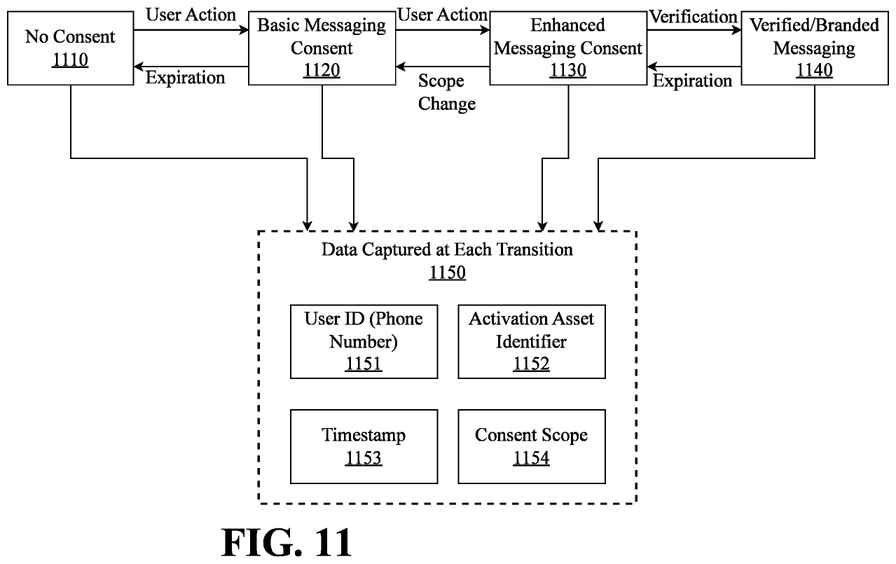

FIG. 11 is a state diagram illustrating a multi-state opt-in state machine, according to an embodiment. The diagram shows four distinct consent states and the transitions between them, demonstrating how the system models opt-in as a structured, graduated consent framework rather than a binary permission flag. This multi-state approach enables the system to manage different levels of messaging permissions with precision, to enforce protocol-specific eligibility requirements, and to maintain compliance with varying consent scopes as users progress through different engagement stages.

The state machine comprises four consent states: no consent 1110, basic messaging consent 1120, enhanced messaging consent 1130, and verified/branded messaging 1140. No consent 1110 represents the initial state in which no messaging is permitted to the user, serving as the default state before any opt-in event has been captured. Basic messaging consent 1120 represents a state in which SMS and MMS messaging is permitted, enabling standard text-based communications but not enhanced protocol features. Enhanced messaging consent 1130 represents a state in which RCS messaging with rich features is permitted, enabling the use of rich cards, interactive buttons, branded sender identity, and rich media content. Verified/branded messaging 1140 represents the highest consent level in which business-verified branded messaging capabilities are enabled, typically requiring completion of external verification processes that confirm business identity and authorization for branded communications.

The state machine supports bidirectional transitions between states, allowing both progression to higher consent levels and regression to lower consent levels based on various triggering events. This bidirectional capability is essential for maintaining accurate consent status over time as user preferences, authorization status, and external verification conditions change. Forward transitions from no consent 1110 to basic messaging consent 1120, from basic messaging consent 1120 to enhanced messaging consent 1130, and from enhanced messaging consent 1130 to verified/branded messaging 1140 may be triggered by user action, wherein the user actively interacts with an activation asset or explicitly grants additional permissions, or by verification processes, wherein external systems confirm authorization for higher-level messaging capabilities.

Backward transitions in the reverse direction may be triggered by multiple types of events that reduce the applicable consent level. Expiration events may cause transitions from basic messaging consent 1120 back to no consent 1110, or from enhanced messaging consent 1130 back to basic messaging consent 1120, or from verified/branded messaging 1140 back to enhanced messaging consent 1130, when time-limited consent periods conclude or when periodic reconfirmation requirements are not satisfied. Scope changes may trigger backward transitions when campaign parameters change in ways that invalidate previously granted permissions, or when consent that was granted for specific purposes or campaigns is no longer applicable to current interaction contexts. Loss of verification status may trigger transitions from verified/branded messaging 1140 to lower states when external verification systems revoke business authorization or when verification credentials expire.

At each state transition, whether forward or backward, the system captures data 1150 comprising multiple data elements that provide context and audit capability for the consent change. This comprehensive data capture ensures that the system maintains a complete record of how and why consent states have evolved over time, enabling compliance verification, dispute resolution, and optimization of consent management strategies. The captured data includes user identifier 1151, which comprises the phone number serving as the identity anchor and enabling the system to associate the consent state change with the correct persistent identity profile. The captured data further includes activation asset identifier 1152, which identifies the specific digital activation asset, campaign, QR code, call-to-action button, or other triggering mechanism that initiated the consent state change, enabling attribution of consent events to specific marketing initiatives or user touchpoints.

The captured data further includes timestamp 1153, which records the exact date and time of the state transition with sufficient precision to support audit requirements, compliance verification, and temporal analysis of consent patterns. The captured data further includes consent scope 1154, which specifies the extent and limitations of the messaging permissions granted or revoked during the transition, including information about which protocols are authorized, which message types are permitted, what campaign contexts are covered, what duration applies to the consent, and any other restrictions or qualifications that define the boundaries of the granted permissions. This consent scope information is critical for ensuring that subsequent messaging operations remain within the bounds of user authorization and that the channel eligibility service can accurately determine which protocols and features may be used for communications with this identity.

This multi-state consent model enables the system to enforce graduated messaging eligibility based on precise consent status, to maintain a complete audit trail of consent changes over time, and to ensure that messaging protocol selection and feature enablement remain compliant with the user's current consent state as managed by the opt-in state manager. The state machine architecture allows consent status to evolve naturally as users engage more deeply with the system and as external conditions change, while preserving the ability to restrict permissions when authorization expires or when circumstances require reduced access. By capturing comprehensive contextual data at each transition, the system creates an auditable record that supports compliance with privacy regulations, enables analysis of consent patterns to optimize opt-in strategies, and provides the foundational data that the opt-in state manager uses to gate access to different messaging protocols and features throughout the user's engagement lifecycle.

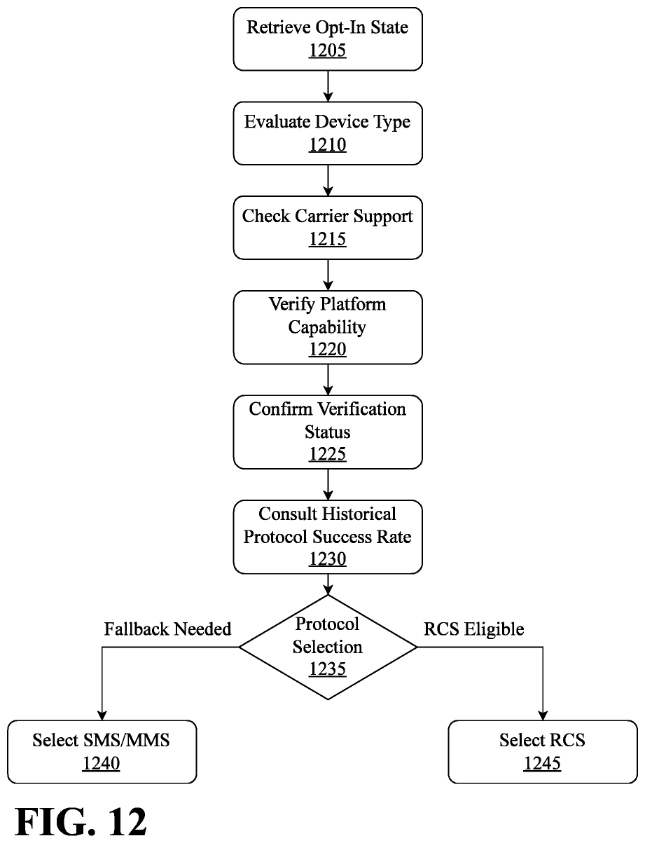

FIG. 12 is a method diagram illustrating steps for channel eligibility determination process flow, according to an embodiment. The diagram shows a sequential evaluation process that considers multiple factors to determine which messaging protocol is eligible for use in a given interaction, and demonstrates how the system separates channel eligibility determination from message generation and delivery as a distinct processing layer that executes after opt-in capture and before message formatting.

The process begins at step 1205, where the system retrieves opt-in state information from the opt-in state manager. This initial step establishes the consent boundaries within which the channel eligibility determination must operate, ensuring that no messaging protocol or feature is selected that exceeds the user's granted permissions. The retrieved opt-in state indicates whether the user has granted no consent, basic messaging consent, enhanced messaging consent, or verified/branded messaging consent, and this information governs all subsequent eligibility evaluations by defining which protocols are authorized for consideration.

At step 1210, the system evaluates device type to determine what messaging capabilities may be supported by the user's device. Device type evaluation considers whether the device is a smartphone, tablet, desktop computer, or other device category, what operating system is running on the device, what messaging applications are installed or available on the device, and what technical specifications or limitations the device may impose on messaging protocol support. This device type information is essential for determining whether enhanced messaging protocols such as RCS can be successfully delivered to the device, as RCS support varies significantly across device types, manufacturers, operating system versions, and messaging client configurations.

At step 1215, the system checks carrier support to verify whether the user's mobile carrier or network operator provides the necessary infrastructure to support enhanced messaging protocols. Carrier support evaluation determines whether the carrier network has deployed RCS infrastructure, whether the carrier has enabled RCS services for the specific phone number or account in question, what limitations or restrictions the carrier may impose on RCS usage, and whether fallback to SMS or MMS would be required if RCS is unavailable through the carrier network. This carrier support check is critical because RCS capability depends not only on device support but also on network-level enablement by the carrier, and a device that is technically capable of RCS may still be unable to receive RCS messages if the carrier does not support the protocol.

At step 1220, the system verifies platform capability to confirm that the broader messaging platform infrastructure can support the intended message features and protocol requirements. Platform capability verification considers whether the messaging gateway has the necessary interfaces to external RCS platform services, whether API connections to carrier RCS networks are operational and accessible, whether the system has obtained necessary business verification credentials to enable branded messaging features, and whether any platform-level rate limits, quotas, or restrictions would prevent use of enhanced messaging protocols. This verification ensures that the system's own infrastructure is capable of delivering the selected protocol before committing to a protocol selection decision.

At step 1225, the system confirms verification status to determine whether business verification requirements have been satisfied for branded or verified messaging. Verification status confirmation checks whether the business sender has completed verification processes with RCS platform providers, whether verification credentials are current and have not expired, whether the specific message content or use case falls within the scope of granted verification permissions, and whether any verification-dependent features such as branded sender identity or verified badges can be enabled for this interaction. For certain enhanced messaging features, particularly those involving business branding and verified sender status, verification is a prerequisite that must be confirmed before those features can be utilized.

At step 1230, the system consults historical protocol success rate data to inform the protocol selection decision with empirical evidence of past performance. This consultation examines data from the user's identity profile showing which protocols have been successfully used in prior interactions with this specific user, what delivery success rates have been achieved for different protocols when communicating with this phone number, whether any prior protocol failures or delivery issues have been recorded that would suggest avoiding certain protocols, and what patterns of protocol preference or optimal performance have emerged from accumulated interaction history. This historical data enables the system to learn from experience and to favor protocols that have proven reliable for this particular user, even when multiple protocols are technically eligible.

Following these sequential evaluations, the process reaches a protocol selection decision point 1235, where the system determines whether RCS is eligible and should be selected, or whether fallback to SMS or MMS is needed. If all eligibility criteria are satisfied, meaning that opt-in state permits enhanced messaging, device type supports RCS, carrier support is confirmed, platform capability is verified, verification status is adequate, and historical success rates are favorable, then the system selects RCS at step 1245, enabling the use of rich cards, interactive buttons, branded sender identity, rich media, and other enhanced features. If any eligibility criterion is not satisfied, meaning that one or more of the evaluated factors indicates that RCS cannot be successfully used, then the system selects SMS or MMS at step 1240, ensuring that the message can be delivered using a universally supported fallback protocol while preserving the core interaction intent through adapted formatting. This decision structure ensures that the system always selects a viable messaging protocol based on comprehensive evaluation of consent, technical capability, and empirical performance data, and that messages are delivered successfully even when enhanced protocols are unavailable.

The output of this channel eligibility determination process includes the selected protocol, capability constraints that define which features are available within the selected protocol, and fallback ordering that specifies which alternative protocols should be attempted if the primary selection fails during delivery. This information is then provided to the capability-aware message constructor for use in formatting the message appropriately, and to the messaging gateway for use in executing the delivery operation, ensuring that protocol selection decisions are based on systematic evaluation of all relevant eligibility factors rather than on assumptions or default settings.

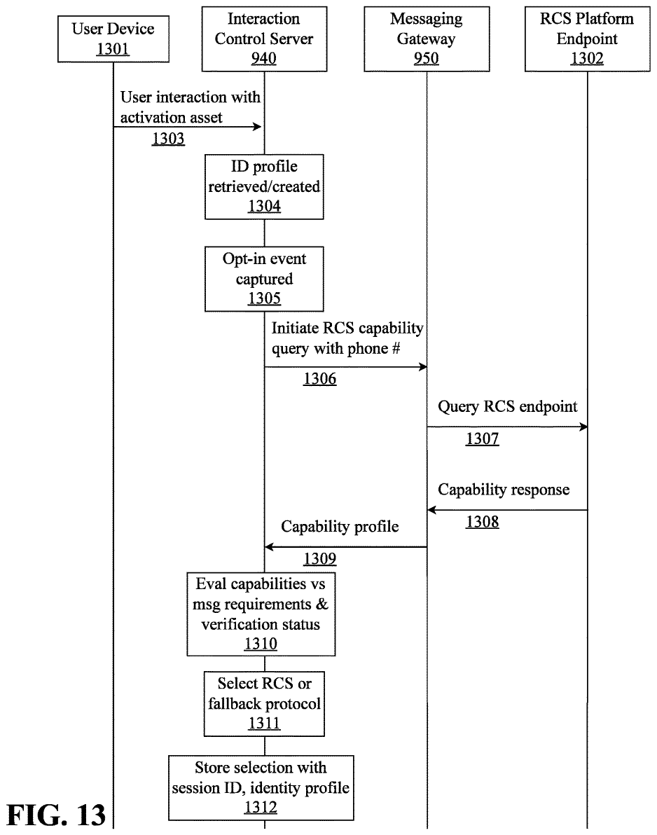

FIG. 13 is a sequence diagram illustrating the RCS capability negotiation detailed sequence, according to an embodiment. The diagram shows the message flow and processing steps that occur when the system dynamically queries external RCS platform services to determine whether enhanced messaging capabilities are available for a specific phone number, and demonstrates how capability negotiation coordinates between the interaction control server, messaging gateway, and external RCS infrastructure to make informed protocol selection decisions based on real-time capability data.

The sequence involves four principal components: user device 1301, interaction control server 940, messaging gateway 950, and RCS platform endpoint 1302. The user device 1301 is the mobile device or other computing device through which the user interacts with digital activation assets and receives messages. The interaction control server 940 is the central system component that manages identity, opt-in state, channel eligibility, and protocol selection decisions as described in previous figures. The messaging gateway 950 is the component responsible for interfacing with various messaging protocols and delivery networks, including the RCS platform interface that communicates with external RCS services. The RCS platform endpoint 1302 is an external service operated by a carrier, RCS business messaging provider, or RCS platform operator that provides capability information and facilitates RCS message delivery.

The sequence begins at step 1303, where user interaction with activation asset occurs as the user device 1301 engages with a digital activation asset such as a QR code, call-to-action button, redirect link, or other initiator. This interaction triggers the device to send an interaction signal to the interaction control server 940, initiating the engagement flow that will ultimately result in message delivery. The interaction signal includes contextual information such as the activation asset identifier, device metadata, and the phone number associated with the user device, providing the interaction control server with the information needed to begin processing the interaction.

At step 1304, the interaction control server 940 retrieves or creates an identity profile anchored to the phone number received from the user device. If an existing identity profile is found in the persistent identity management service for the provided phone number, the system retrieves that profile along with all accumulated interaction history, opt-in state, device associations, protocol preferences, and other contextual data. If no existing identity profile is found, the system creates a new identity record with the phone number serving as the primary key and identity anchor, establishing the foundation for future data accumulation. This identity profile retrieval or creation ensures that the system has access to all available historical context about the user when making subsequent processing decisions.

At step 1305, the interaction control server 940 captures an opt-in event triggered by the user's interaction with the activation asset. The opt-in event capture records the user identifier, activation asset identifier, timestamp, and consent scope associated with this interaction, and updates the opt-in state maintained by the opt-in state manager. This opt-in capture establishes or confirms the user's consent to receive messages and determines what level of messaging permissions apply, whether basic messaging consent, enhanced messaging consent, or verified/branded messaging consent. The captured opt-in state will govern whether RCS capability negotiation should proceed or whether the system should default to SMS or MMS without attempting to use enhanced protocols.

At step 1306, assuming that the opt-in state permits enhanced messaging, the channel eligibility service within the interaction control server 940 initiates an RCS capability query by sending a request to the messaging gateway 950 that includes the phone number for which capability information is needed. This query represents the decision point at which the system moves from consent evaluation to technical capability assessment, seeking to determine whether the user's device and carrier infrastructure can support RCS messaging. The query may also include additional contextual information such as the intended message features, required capabilities, or verification status to enable more precise capability matching.

At step 1307, the messaging gateway 950, through its RCS platform interface, queries the RCS platform endpoint 1302 to retrieve capability information for the specified phone number. This query is transmitted over network connections to external RCS infrastructure operated by carriers or RCS platform providers, using protocols and APIs defined by RCS standards and platform specifications. The query provides the phone number as the lookup key and requests detailed information about what RCS features and capabilities are supported for that number, enabling the system to make informed decisions about whether RCS can be used and what features are available.

At step 1308, the RCS platform endpoint 1302 returns a capability response to the messaging gateway 950 containing detailed information about RCS support status and available features. The capability response indicates whether RCS is supported at all for the queried phone number, whether the user's device has RCS enabled, whether the carrier network supports RCS for this number, what specific RCS features are available including support for rich cards, interactive buttons, suggested replies, rich media, branded sender identity, and persistent sessions, and what limitations or restrictions apply such as message size limits, supported media types, or feature availability constraints. This capability response provides the empirical data needed to determine whether RCS is a viable protocol choice for this interaction.

At step 1309, the messaging gateway 950 forwards the capability profile back to the interaction control server 940, making the retrieved capability information available to the channel eligibility service for evaluation. At step 1310, the channel eligibility service evaluates the received capabilities against message requirements and verification status to determine whether RCS is sufficient for the intended interaction. This evaluation compares the available RCS features reported in the capability response against the features that the intended message requires, such as whether the message design needs interactive buttons that are supported, whether rich media content can be delivered, whether branded sender identity is both available and authorized through business verification, and whether any capability limitations would prevent essential message features from functioning correctly. Based on this evaluation, the system selects either RCS if capabilities are sufficient and verification is confirmed, or a fallback protocol such as SMS or MMS if RCS is unavailable or inadequate.

At step 1311, the interaction control server 940 makes the final protocol selection decision, choosing RCS if the capability evaluation was favorable or selecting a fallback protocol if RCS is not viable. At step 1312, the selected protocol, along with capability constraints that define which features are available within that protocol, is stored with the session identifier and identity profile. This storage serves multiple purposes: it associates the protocol selection with the current interaction session, enabling session continuity if protocol transitions are needed later; it updates the identity profile with information about protocol usage and capability for this phone number, contributing to the historical protocol success rate data that will inform future interactions; and it provides the information that the capability-aware message constructor needs to format the message appropriately for the selected protocol. The storage of this selection data completes the capability negotiation sequence and enables the system to proceed to message construction and delivery using the protocol that has been determined to be both authorized by opt-in state and technically feasible based on capability negotiation.

This RCS capability negotiation sequence demonstrates how the system dynamically assesses technical capability in real-time rather than relying on assumptions or cached capability data, how external RCS platform services are queried to obtain authoritative capability information, and how capability negotiation coordinates seamlessly with opt-in state evaluation and protocol selection to ensure that messages are delivered using the most capable protocol that is both permitted and technically feasible for each specific user interaction.

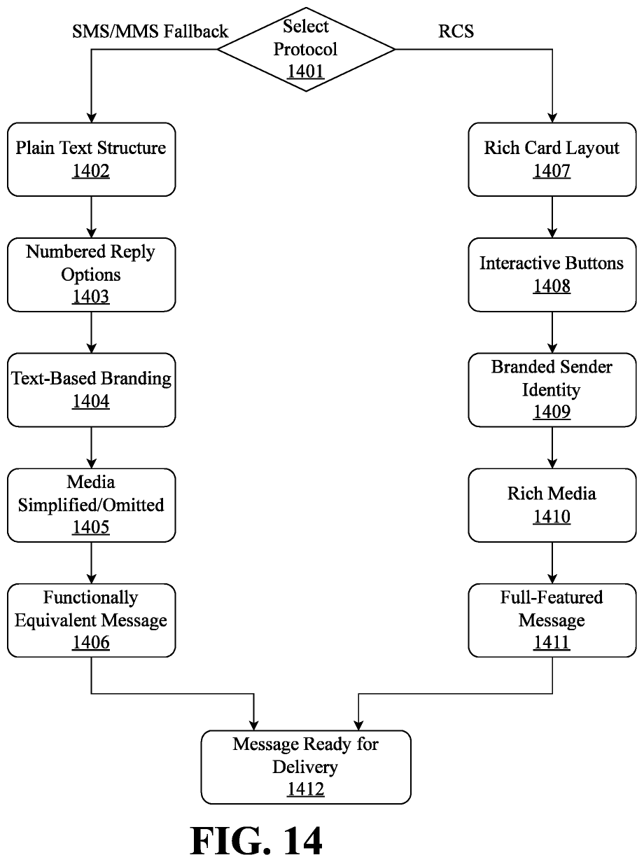

FIG. 14 is a flowchart diagram illustrating capability-aware message construction for dual protocols, according to an embodiment. The diagram shows how the system adapts message formatting and features based on the selected messaging protocol while preserving the core interaction intent, and demonstrates the parallel construction paths that enable the same underlying interaction logic to be expressed through either rich RCS features or adapted SMS/MMS formatting depending on protocol availability and eligibility.

The process begins at step 1401, where the system receives the protocol selection decision from the channel eligibility service. This protocol selection represents the output of the capability negotiation and eligibility determination processes described in previous figures, indicating whether RCS has been selected based on successful capability negotiation and opt-in authorization, or whether SMS or MMS has been selected as a fallback protocol due to capability limitations, consent restrictions, or other eligibility factors. The protocol selection decision determines which of two parallel message construction paths will be followed to format the message for delivery.

When RCS is the selected protocol, the system follows the RCS construction path beginning at step 1407, where rich card layout formatting is applied to structure the message content in an engaging visual presentation. Rich card layout 1407 enables the message to be presented with structured visual elements including headers, body text sections, images positioned within defined layout regions, and organized information hierarchies that enhance readability and user engagement compared to plain text formats. This rich layout capability leverages RCS protocol features to create messages that resemble interactive application interfaces rather than simple text messages, providing a more sophisticated and branded user experience.

At step 1408, interactive buttons are added to the RCS message to enable user actions without requiring typed responses. Interactive buttons 1408 allow users to select from predefined response options, trigger specific actions such as opening URLs or initiating calls, provide feedback or confirmations, or navigate through multi-step interaction flows, all through simple button taps rather than text entry. These interactive elements reduce friction in user engagement, eliminate ambiguity in user responses by providing structured options rather than free-form text, and enable more complex interaction patterns that guide users through intended engagement sequences.

At step 1409, branded sender identity is applied to the RCS message to display verified business information and enhance trust. Branded sender identity 1409 shows the business name, logo, and verification badge within the message interface, indicates to the user that the message originates from a verified business entity rather than an unknown sender, and reinforces brand recognition and legitimacy through consistent visual identity presentation. This branding capability is particularly valuable for business-to-consumer communications where establishing sender authenticity and trustworthiness is critical to user engagement and conversion.

At step 1410, rich media content is incorporated into the RCS message to enhance engagement through visual and multimedia elements. Rich media 1410 may include high-resolution images that showcase products or convey visual information, video content that demonstrates features or tells stories, audio elements for voice messages or sound effects, interactive carousels that allow users to browse multiple items, and other multimedia content types supported by the RCS protocol. This rich media capability transforms the message from a text-based communication into a multimedia experience that can convey information more effectively and engage users more deeply than text alone.

The RCS construction path concludes at step 1411, where the full-featured message is completed with all available RCS capabilities integrated into a cohesive, interactive, branded, and multimedia-rich communication that leverages the enhanced features of the RCS protocol to deliver an optimal user experience. This full-featured message represents the highest-quality output that the system can produce when technical capabilities and consent permissions align to enable enhanced messaging.

When SMS or MMS is the selected protocol due to RCS being unavailable or ineligible, the system follows the SMS/MMS fallback construction path beginning at step 1402, where plain text structure is applied to format the message content in a linear text format compatible with SMS and MMS protocols. Plain text structure 1402 converts any visual layout elements from the original message design into sequential text content, organizes information hierarchically using text formatting techniques such as line breaks and spacing, and presents content in a format that can be rendered in standard text messaging interfaces without requiring rich layout capabilities. This conversion ensures that the message content remains accessible and comprehensible even when rich formatting is unavailable.

At step 1403, numbered reply options are created to replace interactive buttons with text-based alternatives that preserve interaction functionality. Numbered reply options 1403 present user choices as a list with numeric identifiers such as “Reply 1 for Option A, 2 for Option B,” instruct users to respond with the number corresponding to their selection, and enable the system to interpret numeric text responses as equivalent to button selections from the RCS version. This adaptation maintains the structured interaction pattern and eliminates ambiguity in user responses, even though the interface mechanism changes from interactive buttons to text-based instructions.

At step 1404, text-based branding is applied to preserve sender identification and business identity within the constraints of SMS and MMS protocols. Text-based branding 1404 includes the business name in the message content or sender identification field, may incorporate text-based representations of branding elements such as taglines or identifiers, and maintains consistent messaging tone and language that reinforces brand identity even without visual logos or verification badges. This text-based approach ensures that users can identify the message sender and recognize the business origin, even though the visual branding elements available in RCS are not supported.

At step 1405, media is simplified or omitted to adapt to the limited multimedia capabilities of SMS and MMS protocols. Media simplified or omitted 1405 may involve converting images to text descriptions when visual content is essential to message understanding, including MMS image attachments when the fallback protocol is MMS rather than SMS and when critical visual information must be conveyed, or omitting media entirely when it serves decorative rather than informational purposes and when text content alone suffices to convey the intended message. This media adaptation ensures that the message can be delivered through protocols with limited or no multimedia support while preserving the essential informational content.

The SMS/MMS construction path concludes at step 1406, where the functionally equivalent message is completed with all necessary adaptations applied to ensure that the core interaction intent is preserved despite protocol limitations. Functionally equivalent message 1406 may lack the visual sophistication, interactivity, and multimedia richness of the RCS version, but delivers the same essential information, enables the same user actions through adapted mechanisms, and achieves the same interaction objectives within the constraints of SMS and MMS protocols. This functional equivalence ensures that users receive valuable and actionable communications regardless of their device or protocol capabilities.

Both construction paths converge at step 1412, where the message ready for delivery is produced in the appropriate format for the selected protocol. Message ready for delivery 1412 represents the final formatted message that will be transmitted to the messaging gateway for delivery, complete with all protocol-specific formatting applied, all features adapted to available capabilities, and all content structured for optimal rendering in the target messaging environment. The message is accompanied by metadata including the selected protocol, capability constraints that define which features are active, session identifiers for continuity tracking, and delivery instructions that specify how the message should be transmitted.

This dual-path construction approach enables the system to maintain consistent interaction logic and message intent across different protocol capabilities, to automatically adapt message formatting based on available features without requiring separate message authoring for each protocol, and to ensure that users receive high-quality communications optimized for their specific device and protocol capabilities while preserving functional equivalence across all delivery scenarios. The capability-aware message constructor applies these adaptations transparently based on the protocol selection output from the channel eligibility service, ensuring that message construction is always aligned with technical feasibility and consent permissions.

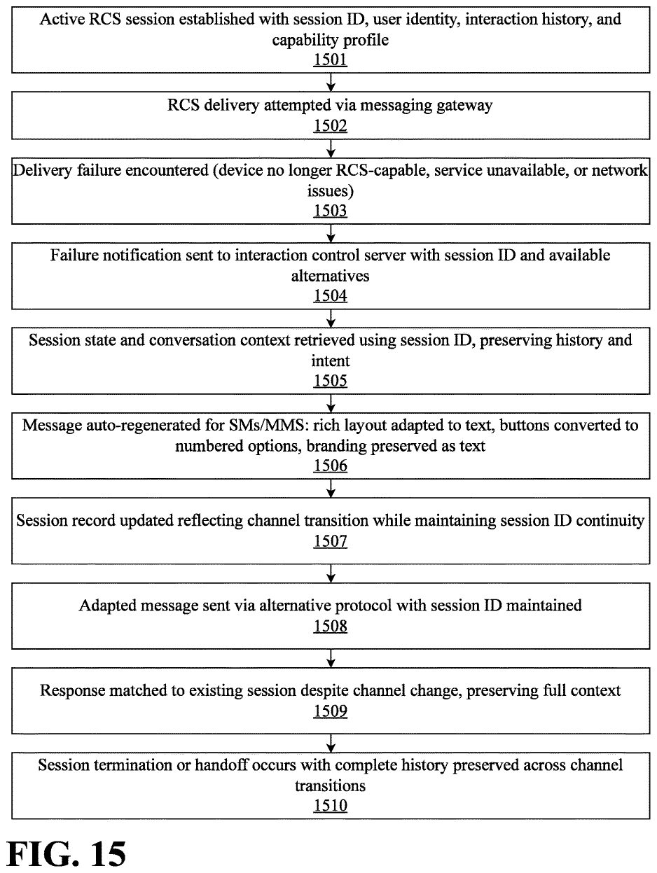

FIG. 15 is a method diagram illustrating steps for maintaining session continuity and seamless fallback during RCS to SMS channel transition, according to an embodiment. The diagram shows how the system preserves conversation context, interaction history, and user intent when transitioning between messaging protocols due to delivery failures or capability changes, and demonstrates the mechanisms that enable uninterrupted user experience despite underlying technical constraints that necessitate protocol switching during active messaging sessions.

The process begins at step 1501, where an active RCS session is established with session ID, user identity, interaction history, and capability profile. This initial session establishment creates the foundational data structures that enable session continuity throughout the interaction lifecycle. The session ID serves as a unique identifier that links all messages, user responses, and system actions within this conversation thread, enabling the system to track and maintain context across multiple message exchanges and potential protocol transitions. The user identity, anchored to the phone number as described in previous figures, connects the session to the persistent identity profile maintained by the persistent identity management service, providing access to accumulated contextual data about the user's preferences, history, and characteristics. The interaction history within the session records all prior messages exchanged, user actions taken, and system responses provided during this specific engagement, creating a temporal record of the conversation flow. The capability profile documents the RCS features that were negotiated and confirmed as available for this session, defining which enhanced messaging capabilities are active and can be utilized in message formatting.

At step 1502, RCS delivery is attempted via the messaging gateway as the system seeks to transmit a message to the user device using the RCS protocol and the enhanced features that were enabled based on capability negotiation and opt-in state. This delivery attempt represents the normal execution path when RCS has been selected as the messaging protocol and when all eligibility criteria were satisfied at the time of channel selection. The messaging gateway, through its RCS platform interface, transmits the formatted RCS message to external RCS platform services or carrier networks for delivery to the user's device, expecting that the capability profile established during session initialization remains valid and that the device remains reachable via RCS infrastructure.

At step 1503, a delivery failure is encountered as the RCS message cannot be successfully delivered to the user device. The delivery failure may occur for multiple reasons: the device may no longer be RCS-capable due to software updates, configuration changes, or application uninstallation that have occurred since the session was established; the RCS service may be unavailable due to carrier network outages, platform maintenance, service disruptions, or infrastructure failures affecting the RCS delivery path; or network issues such as connectivity problems, signal loss, data service interruptions, or device transitions to networks that do not support RCS may prevent message delivery. Any of these conditions results in a failure indication from the RCS platform or messaging gateway, signaling that the intended delivery cannot be completed using the originally selected protocol.

At step 1504, a failure notification is sent to the interaction control server with session ID and available alternatives, alerting the system to the delivery problem and providing information needed to execute a recovery strategy. The failure notification includes the session ID that identifies which conversation thread experienced the delivery failure, enabling the system to retrieve the full session context and conversation history. The notification also includes information about available alternatives, indicating which fallback protocols such as SMS or MMS may be used to deliver the message, what technical details about the failure reason may inform the fallback approach, and what capabilities or constraints apply to alternative delivery methods. This notification triggers the session continuity mechanisms that will enable the conversation to continue despite the protocol transition.

At step 1505, session state and conversation context are retrieved using session ID, preserving history and intent as the system accesses all information necessary to continue the interaction seamlessly. The session continuity manager, using the session ID from the failure notification, retrieves the complete session record from storage, recovering all messages that have been exchanged in this conversation, all user actions and responses that have occurred, all system state and context variables that define where the interaction stands in its flow, and all attribution and campaign metadata that connect this session to specific marketing initiatives or business objectives. This retrieval is critical because it ensures that the protocol transition does not result in loss of conversation context, that the user is not required to repeat information or restart the interaction, and that the system can continue from exactly where the conversation stood before the delivery failure occurred, maintaining continuity of the user experience.

At step 1506, the message is auto-regenerated for SMS/MMS with rich layout adapted to text, buttons converted to numbered options, and branding preserved as text, applying the same capability-aware message construction logic described in FIG. 14 to reformat the failed RCS message for delivery via a fallback protocol. The system transforms the rich card layout that was designed for RCS into a plain text structure that presents the same information in linear format compatible with SMS display limitations. Interactive buttons that enabled tap-based user actions in the RCS version are converted to numbered reply options with text instructions such as “Reply 1 for Option A, 2 for Option B,” preserving the structured interaction pattern while adapting to the constraints of text-based protocols. Branded sender identity that was displayed visually through logos and verification badges in RCS is preserved as text-based branding through inclusion of the business name in message content or sender identification. Any rich media that was included in the RCS message is simplified or omitted based on MMS capabilities if MMS is the fallback protocol, or removed entirely if SMS is the fallback, with essential visual information converted to text descriptions where necessary. Throughout this regeneration process, the core interaction intent is preserved, ensuring that the fallback message serves the same purpose and enables the same user actions as the original RCS message, even though the presentation and interaction mechanisms are adapted to protocol constraints.

At step 1507, the session record is updated reflecting channel transition while maintaining session ID continuity, documenting the protocol change in system records while preserving the association between all messages and responses within the same conversation thread. The session record is modified to indicate that a protocol transition has occurred, recording that the session began with RCS but has transitioned to SMS or MMS due to delivery failure. The capability profile associated with the session is updated to reflect the features and constraints of the fallback protocol, replacing the RCS feature set with the more limited capabilities of SMS or MMS while maintaining a record that RCS was attempted and failed. Critically, the session ID remains unchanged throughout this transition, ensuring that this is treated as a continuation of the existing conversation rather than as a new, separate interaction. The transition event is logged with timestamp and reason information for analytics and operational monitoring purposes, contributing to the historical protocol success rate data that will inform future protocol selection decisions for this user.

At step 1508, the adapted message is sent via alternative protocol with session ID maintained, as the messaging gateway delivers the reformatted message using SMS or MMS while preserving the session identifier that links this message to the conversation thread. The fallback protocol is used to transmit the message through standard SMS or MMS delivery networks, which have broader compatibility and reliability than RCS but lack the enhanced features. The message includes or is associated with the session ID through encoding in message content, metadata structures, or system linkages that enable subsequent user responses to be matched back to this session. The user receives the message via SMS or MMS on their device, experiencing what appears to be a seamless continuation of the conversation, potentially unaware that a protocol transition has occurred transparently in the background to ensure message delivery.

At step 1509, the user response is matched to the existing session despite channel change, preserving full context as the system processes user replies received via the fallback protocol as part of the ongoing conversation. When the user replies to the adapted message using standard SMS reply functionality, whether by typing a free-form response or by sending one of the numbered options that replaced the interactive buttons, the messaging gateway receives the SMS response and forwards it to the interaction control server along with the session ID that associates this response with the conversation thread. The interaction control server uses the session ID to retrieve the session state and match the user's response to the appropriate point in the conversation flow, interpreting the response in the context of the full interaction history despite the response arriving via a different protocol than the protocol used when the session began. The system processes numbered option selections by mapping them to the equivalent button actions from the original RCS message design, and handles free-form text responses based on what was requested in the adapted message. The full conversation context, including messages exchanged via RCS before the transition and messages exchanged via SMS after the transition, is maintained as a unified session, enabling proper attribution, analytics, and interaction flow management without disruption due to the protocol change.

At step 1510, session termination or handoff occurs with complete history preserved across channel transitions, concluding the interaction while maintaining a comprehensive record of all events including the protocol transition. When the conversation reaches its natural conclusion through completion of the intended action, user disengagement, timeout, or explicit termination, or when the session is handed off to downstream lead destinations such as customer relationship management systems, sales agents, or call centers for continued engagement, the complete session history is preserved in the identity profile and system records. This preserved history includes all messages exchanged regardless of which protocol was used for each message, documentation of the RCS to SMS transition including when it occurred and why it was necessary, all user responses and interactions across both the RCS and SMS segments of the conversation, attribution and campaign tracking data linking the session to specific marketing initiatives, and outcome or disposition information indicating what was accomplished or what next steps are planned. This complete preservation enables comprehensive analytics showing the full user journey despite protocol variations, supports downstream systems with full context for follow-up interactions, maintains compliance and audit trails documenting the complete interaction sequence, and informs future optimization of channel selection and fallback strategies by providing empirical data about when and why protocol transitions occur and how they affect user engagement outcomes.

This session continuity mechanism demonstrates how the system maintains uninterrupted user experience and complete conversation context despite technical constraints that necessitate protocol transitions, how the session ID serves as the critical linking mechanism that preserves thread continuity across protocol changes, how capability-aware message reconstruction enables functional equivalence across protocols within the same session, and how comprehensive state preservation ensures that no information is lost and no user friction is introduced when the system transparently adapts to changing technical conditions to ensure reliable message delivery.

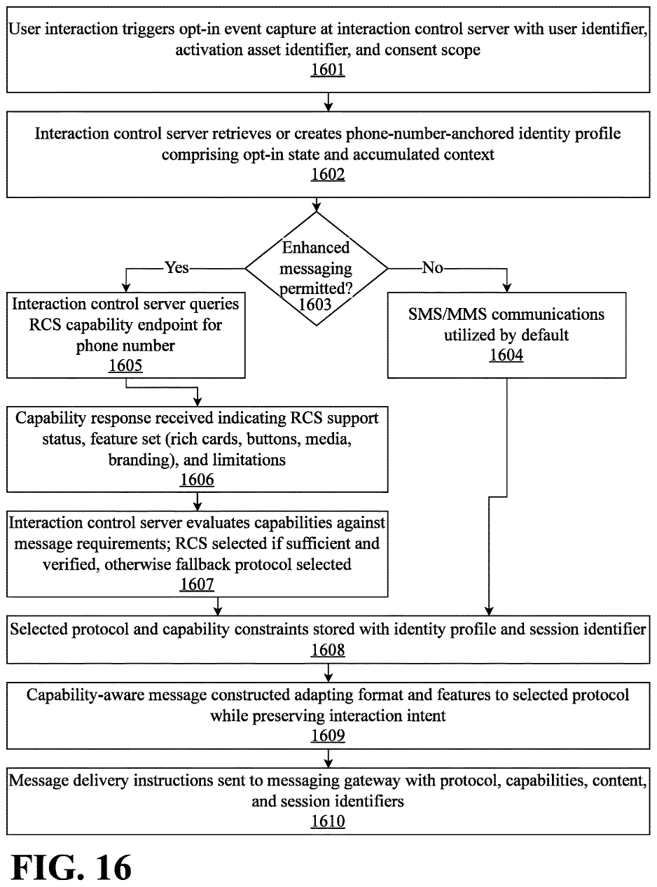

FIG. 16 is a method diagram illustrating steps for opt-in-gated RCS channel eligibility determination and capability negotiation, according to an embodiment. This method demonstrates how the system conditionally enables Rich Communication Services messaging based on opt-in state evaluation and dynamic capability assessment, while providing robust fallback to alternative messaging protocols when RCS is unavailable or ineligible.

A user interaction triggers opt-in event capture at the interaction control server with user identifier, activation asset identifier, and consent scope 1601. The user interaction may result from activation of a digital activation asset such as a call-to-action button, redirect link, or QR code as described in other figures herein. The captured opt-in event comprises identifying information such as a phone number serving as the user identifier, an identifier associated with the specific activation asset that triggered the interaction, campaign or product context, and consent scope parameters indicating the type and extent of messaging permissions being granted. This opt-in event serves as a structured system input that governs subsequent messaging behavior and channel eligibility determinations, rather than merely serving as a binary permission flag.

The interaction control server retrieves or creates a phone-number-anchored identity profile comprising opt-in state and accumulated context 1602. The interaction control server, utilizing identity management service 641 as illustrated in FIG. 6, queries an identity database using the phone number from the previous step as the primary key. If an existing identity profile is found, the system retrieves accumulated data including prior opt-in records, interaction history, device associations, communication preferences, and contextual observations collected over time. If no existing profile is found, the system creates a new identity record with the phone number serving as the persistent identifier or “identity DNA” that will anchor all future interactions and data accumulation for this user. The identity profile serves as a persistent repository for compounding intelligence about the user's preferences, behaviors, and engagement patterns.

The system evaluates whether enhanced messaging is permitted 1603. The opt-in state manager 642 within the interaction control server evaluates the opt-in state information retrieved or established in the preceding step, considering the consent scope parameters captured during opt-in event capture and any applicable time limitations, purpose restrictions, or channel-specific permissions. The system determines whether the opt-in grants permission only for basic messaging (SMS/MMS) or extends to enhanced messaging capabilities including RCS. This evaluation represents a conditional decision point in the method flow that determines whether the system proceeds to evaluate RCS-specific eligibility criteria or immediately selects fallback protocols.

If enhanced messaging is not permitted, SMS/MMS communications are utilized by default 1604. When the opt-in state evaluation at step 1603 determines that enhanced messaging capabilities are not authorized by the user's consent, the method bypasses RCS capability evaluation entirely and proceeds directly to select SMS or MMS as the messaging protocol. This default fallback path ensures that messaging channel selection respects user consent boundaries and compliance requirements from the outset, preventing any attempt to use enhanced features when authorization has not been granted. The system then proceeds to message construction and delivery using the selected fallback protocol while maintaining interaction continuity and session tracking.

If enhanced messaging is permitted, the interaction control server queries an RCS capability endpoint for the phone number 1605. When the opt-in state evaluation at step 1603 determines that enhanced messaging is authorized, the channel eligibility service 643 within the interaction control server, working in coordination with RCS platform interface 651 of the messaging gateway as illustrated in FIG. 6, initiates a capability negotiation process. The system transmits a capability query to an external RCS platform service, carrier network capability endpoint, or RCS business messaging provider, providing the user's phone number as the identifier for which capability information is requested. This query seeks to determine whether the user's device and carrier support RCS messaging and, if so, which specific RCS features and capabilities are available. The capability negotiation may occur in real-time or may retrieve previously cached capability information if such information is available and sufficiently recent.

A capability response is received indicating RCS support status, feature set comprising rich cards, buttons, media, branding, and limitations 1606. The RCS platform interface 651 receives the capability response from the queried endpoint, which contains structured data describing the RCS capabilities available for the specified phone number. The capability response indicates whether RCS is supported at all for this user, and if supported, provides a detailed feature set description. The feature set may indicate support for rich card layouts that enable structured message presentation, interactive buttons and suggested replies that enable user actions without typing, rich media capabilities including images, videos, or documents, branded sender identity elements including business name and logo display, persistent conversation sessions, and any limitations such as message size restrictions, supported media types, or interaction frequency constraints. The capability response may also include information about platform or carrier participation, device compatibility, and verification requirements.

The interaction control server evaluates capabilities against message requirements; RCS is selected if sufficient and verified, otherwise fallback protocol is selected 1607. The channel eligibility service 643 compares the capability profile received in the previous step against the requirements of the intended message interaction, considering factors such as whether the message design requires interactive buttons, rich media, or branded presentation, whether the available RCS capabilities are sufficient to deliver the intended user experience, whether business verification status has been established to enable branded messaging, and whether any capability limitations would prevent essential message features from functioning. Based on this evaluation, the system makes a protocol selection decision. If RCS capabilities are sufficient for the intended interaction and verification status is confirmed, RCS is selected as the messaging protocol and the method proceeds to message construction. If RCS capabilities are insufficient, unavailable, or verification status is incomplete, the system selects an alternative protocol such as SMS or MMS, ensuring that the interaction can proceed despite the unavailability of enhanced features.

The selected protocol and capability constraints are stored with the identity profile and session identifier 1608. The interaction control server records the protocol selection decision and associated capability information in multiple locations for future reference. The selected protocol is associated with the user's identity profile maintained by identity management service 641, enabling the system to reference prior successful protocols when planning future interactions with this user. The capability constraints, which define which features are available or restricted for this interaction, are stored with the session identifier to ensure consistent behavior throughout the current interaction session. Additionally, if RCS capabilities were successfully negotiated, the capability profile may be cached for reuse in future interactions, reducing the need for repeated capability queries. This storage enables the system to learn from each interaction and to apply accumulated knowledge in subsequent engagements.

A capability-aware message is constructed adapting format and features to the selected protocol while preserving interaction intent 1609. The interaction control server prepares the message content using the protocol selected in the prior evaluation step and applying the capability constraints just stored. If RCS was selected, the message is formatted to leverage available RCS features such as rich card layouts, interactive buttons, branded sender identity, and rich media, creating an engaging and visually rich user experience. If SMS or MMS was selected due to RCS unavailability or opt-in limitations, the same interaction intent is expressed using the constraints of the fallback protocol, which may involve converting rich layouts to plain text descriptions, replacing interactive buttons with text-based instructions or numbered reply options, presenting branding information as text identifiers rather than visual elements, and simplifying or omitting media that cannot be delivered via the selected protocol. Throughout this adaptation process, the core interaction logic, call-to-action intent, and essential information content are preserved, ensuring that users receive functionally equivalent experiences regardless of which protocol is ultimately used. This capability-aware construction allows the same underlying interaction design to be expressed appropriately across different messaging channels.

Message delivery instructions are sent to the messaging gateway with protocol, capabilities, content, and session identifiers 1610. The interaction control server transmits a comprehensive message delivery request to messaging gateway 650, providing all information necessary for the gateway to deliver the message successfully. The delivery instructions specify the selected messaging protocol (RCS, SMS, or MMS) determined through the eligibility and capability evaluation process, the capability constraints or feature profile that should be applied if using RCS, the fully formatted message content prepared in the previous step and ready for transmission, session identifiers that enable tracking and attribution of the message within the ongoing interaction session, user identity information including the phone number to which the message should be delivered, and any additional metadata relevant to delivery tracking or analytics. The messaging gateway receives these instructions and proceeds to deliver the message to the user device using the specified protocol and format, completing the opt-in-gated, capability-aware message delivery process. Subsequent user responses or interactions with the delivered message may be processed according to methods described in other figures, with the session identifier enabling continuity across multiple message exchanges.

This method demonstrates how the disclosed system integrates opt-in state management, conditional eligibility evaluation, RCS capability negotiation, protocol selection, and capability-aware message construction into a unified flow that ensures compliant, optimized messaging experiences while maintaining robust fallback capabilities when enhanced features are unavailable. The conditional logic structure at step 1603 ensures that RCS capability negotiation occurs only when authorized by opt-in state, while the default SMS/MMS path 1604 provides immediate fallback when enhanced messaging is not permitted, creating an efficient and compliance-focused channel selection mechanism.

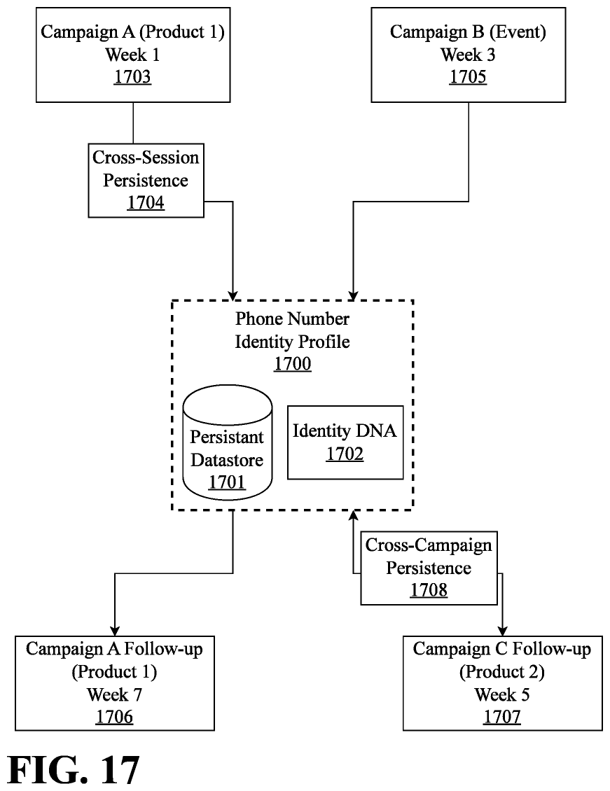

FIG. 17 is a data flow diagram illustrating cross-session and cross-campaign identity persistence, according to an embodiment. The diagram shows how the phone number-anchored identity profile serves as a central, persistent repository that accumulates data from multiple interactions across different campaigns and time periods, and demonstrates how this persistent identity structure enables the system to maintain continuous contextual intelligence that transcends individual campaigns, sessions, and temporal boundaries while eliminating the need for repeated information collection from users.

At the center of the diagram is the phone number identity profile 1700, which represents the persistent database record maintained by the persistent identity management service as described in previous figures. The phone number identity profile 1700 serves as the permanent data structure anchored to a specific phone number that accumulates all interaction data, contextual observations, derived preferences, and engagement history associated with that user identity. This identity profile is stored in a persistent datastore 1701, which may comprise relational databases, non-relational databases, distributed data stores, or other data persistence technologies that ensure the identity record remains available across system restarts, remains durable against hardware failures, and can be retrieved efficiently for use in processing new interactions. The persistent storage of identity data enables the compounding intelligence effect where each new interaction adds to the accumulated knowledge base rather than starting from zero context.

The phone number identity profile 1700 functions as identity DNA 1702, serving as the fundamental genetic code that defines the user's identity within the system and that remains stable and persistent regardless of changes in devices, campaigns, messaging protocols, or time elapsed between interactions. This identity DNA concept emphasizes that the phone number anchor provides more than just a lookup key; it creates a continuous identity thread that links all past, present, and future interactions with this user into a coherent whole, enabling the system to recognize and serve the same user consistently across all touchpoints. Just as biological DNA encodes information that persists throughout an organism's lifetime, the phone number identity profile encodes user information that persists throughout the user's engagement lifecycle with the system, accumulating complexity and richness over time while maintaining stability and continuity.

The diagram illustrates four campaign interactions distributed across time that demonstrate both cross-session and cross-campaign persistence capabilities. Campaign A (Product 1) Week 1 at reference 1703 represents the initial interaction where the user first engages with the system through a campaign promoting a specific product. During this first interaction, occurring in Week 1 of the timeline, fundamental identity data is captured including the opt-in event triggered by the user's engagement with a digital activation asset, the device information from the mobile device used to interact with the campaign, the phone number that serves as the identity anchor and primary key, and initial contextual metadata about the interaction circumstances. This first campaign interaction establishes the identity profile in the persistent datastore and begins the process of accumulating contextual intelligence about this user.

Campaign B (Event) Week 3 at reference 1705 represents a second interaction occurring in Week 3 of the timeline, where the same user identified by the same phone number engages with a different campaign promoting an event rather than a product. During this interaction, the system retrieves the existing identity profile established during Campaign A, recognizing the user based on the phone number anchor despite this being a completely different campaign with different objectives and content. This second interaction contributes additional data to the identity profile including protocol preference information as the system observes which messaging protocol was successfully used and preferred by this user, and time preference data as the system records when the user engaged and begins to identify patterns in preferred communication timing. The accumulation of this data from Campaign B enriches the identity profile beyond what was captured in Campaign A, demonstrating how intelligence compounds across different campaigns that share the same user identity.

Campaign C (Product 2) Week 5 at reference 1707 represents a third interaction occurring in Week 5 of the timeline, where the user engages with yet another campaign, this time promoting a different product than Campaign A. When this interaction occurs, the system again retrieves the identity profile using the phone number anchor, now accessing accumulated data from both Campaign A and Campaign B even though Campaign C is unrelated to either of those prior campaigns in terms of content or objectives. During this Campaign C interaction, the system contributes additional enrichment to the identity profile including refined engagement pattern data as multiple interactions enable the system to identify consistent behaviors and preferences, and accumulated interest signals as the pattern of product and event interests across campaigns reveals information about the user's broader preferences and likely responses to future offers. Critically, the system also uses the accumulated context from prior campaigns to optimize the Campaign C interaction, potentially selecting optimal messaging protocols based on learned preferences, timing communications based on observed patterns, and personalizing content based on demonstrated interests, all without requiring the user to explicitly provide this information again.

Campaign A Follow-up (Product 1) Week 7 at reference 1706 represents a fourth interaction occurring in Week 7 of the timeline, where the user returns to Campaign A, engaging again with content related to the product from the initial interaction. This return to a previously encountered campaign demonstrates cross-session persistence, as the system retrieves the identity profile and recognizes that this user has interacted with this specific campaign before. The system has access to the full context of what occurred during the Week 1 interaction with Campaign A, what messages were sent, what responses were received, what interest was expressed, and what actions were or were not completed. This historical context enables the system to provide a seamless continuation experience where the user returns with full context and no re-collection of information is needed. The system does not ask the user to re-provide contact information, communication preferences, product interests, or other data that was captured during the first Campaign A interaction, because all of that information persists in the identity profile and is immediately available when the user is recognized via phone number. This cross-session persistence within the same campaign eliminates friction and demonstrates respect for the user's time and prior engagement.

The diagram includes two annotation callouts that explicitly identify the two types of persistence enabled by the phone number-anchored identity architecture. Cross-session persistence 1704 is illustrated by the relationship between Campaign A Week 1 and Campaign A Follow-up Week 7, showing how the same campaign can be engaged multiple times by the same user with full context maintained across the temporal gap and across the separate interaction sessions. This persistence ensures that returning users are recognized, that prior interaction history informs current processing, and that users do not experience the friction of being treated as new or unknown when they return to continue an engagement. Cross-campaign persistence 1708 is illustrated by the accumulation of data across Campaign A, Campaign B, Campaign C, and Campaign A Follow-up, showing how a single user identity accumulates intelligence from engagements with completely different campaigns, and how that accumulated intelligence from diverse campaigns enriches the identity profile and improves the quality of every subsequent interaction regardless of which campaign triggers it. This persistence ensures that users receive progressively better personalized experiences as the system learns from all interactions rather than treating each campaign as an isolated silo.

The data flow in the diagram shows arrows connecting campaign interactions to the central phone number identity profile 1700, illustrating how data flows from each campaign interaction into the persistent identity profile, enriching the accumulated intelligence with each engagement. The diagram also implies, though arrows are not explicitly drawn in all directions, that enriched context flows from the identity profile to each new campaign interaction, enabling the system to leverage all accumulated intelligence when processing new engagements. This bidirectional relationship between campaigns and identity profile is fundamental to the compounding intelligence effect: campaigns contribute data to the identity profile, and the identity profile provides context to campaigns, creating a virtuous cycle where each interaction both benefits from and contributes to the accumulated knowledge base.

This cross-session and cross-campaign persistence architecture enables multiple critical capabilities that differentiate this system from conventional approaches. The system eliminates redundant data collection by maintaining persistent identity records that obviate the need to repeatedly request the same information from users across different engagements. The system enables progressive personalization where each interaction improves the quality of future interactions by contributing to accumulated contextual intelligence. The system maintains attribution and analytics across campaigns by linking all interactions to persistent identity records, enabling comprehensive lifetime value analysis and cross-campaign performance measurement. The system reduces user friction by recognizing returning users and providing seamless continuation experiences that respect prior engagement history. The system optimizes communication strategies by learning from all interactions with an identity and applying that learning across all future communications, regardless of campaign boundaries. Together, these capabilities create a user experience that feels intelligent, respectful, and progressively improving over time, while providing businesses with comprehensive intelligence about user preferences, behaviors, and engagement patterns that transcends individual campaign boundaries and enables strategic optimization of customer engagement approaches.

### Exemplary Computing Environment

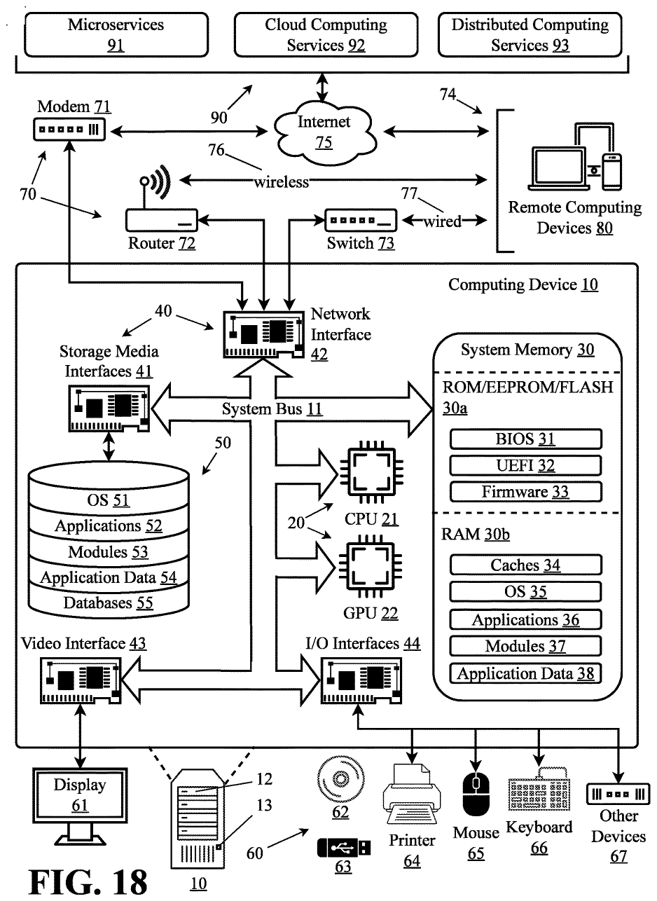

FIG. 18 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A system for persistent identity-based messaging channel optimization and delivery, comprising:
a user device comprising at least a first plurality of programming instructions stored in the memory of, and operating on at least one processor of, a first computing device, wherein the first plurality of programming instructions, when operating on the at least one processor, cause the first computing device to:
interact with digital activation assets over a network;
transmit an interaction comprising a phone number and contextual data; and
receive messages via multiple messaging protocols;
a messaging gateway comprising at least a second plurality of programming instructions stored in the memory of, and operating on at least one processor of, a second computing device, wherein the second plurality of programming instructions, when operating on the at least one processor, cause the second computing device to:
support multiple messaging protocols;
negotiate capabilities with external messaging platform services;
receive messaging instructions from an interaction control server; and
deliver messages to the user device using a selected messaging protocol; and
an interaction control server comprising at least a third plurality of programming instructions stored in the memory of, and operating on at least one processor of, a third computing device, wherein the third plurality of programming instructions, when operating on the at least one processor, cause the third computing device to:
receive the interaction from the user device comprising the phone number and contextual data;
maintain persistent user identity profiles anchored to phone numbers as primary identifiers;
capture an opt-in event associated with the interaction;
maintain multi-state opt-in information governing messaging eligibility;
determine messaging protocol eligibility based on the multi-state opt-in information and capabilities retrieved from external messaging platform services;
select a messaging protocol based on the determined eligibility;
construct capability-aware messages adapted to the selected messaging protocol;
assign session identifiers to interactions and maintain session state;
instruct the messaging gateway to deliver messages using the selected messaging protocol; and
route user interactions to one or more downstream lead destinations.

2. The system of claim 1, wherein the messaging gateway and the interaction control server operate on the same computing device.

3. The system of claim 1, wherein the persistent user identity profiles accumulate interaction history, device associations, protocol usage history, and opt-in state history across multiple sessions and campaigns.

4. The system of claim 1, wherein the multi-state opt-in information comprises multiple opt-in states indicating different messaging eligibility levels.

5. The system of claim 1, wherein the interaction control server is further configured to query external messaging platform capability endpoints using the phone number to retrieve capability profiles.

6. The system of claim 1, wherein the capability-aware message construction adapts message format and features to selected protocol capabilities while preserving interaction intent.

7. The system of claim 1, wherein the interaction control server is further configured to, upon receiving a delivery failure notification, retrieve session context using the session identifier and regenerate the message for an alternative messaging protocol while maintaining the session identifier.

8. The system of claim 1, wherein the interaction control server is further configured to apply inference logic to accumulated identity data to derive implicit user preferences.

9. The system of claim 1, wherein the multiple messaging protocols comprise Rich Communication Services (RCS), Short Message Service (SMS), and Multimedia Messaging Service (MMS).

10. The system of claim 1, wherein the interaction control server is further configured to store the selected messaging protocol with the persistent user identity profile and the session identifier.

11. A method for persistent identity-based messaging channel optimization and delivery, comprising the steps of:
interacting with digital activation assets over a network, using a user device;
transmitting an interaction comprising a phone number and contextual data, using a user device;
receiving messages via multiple messaging protocols, using a user device;
supporting multiple messaging protocols, using a messaging gateway;
negotiating capabilities with external messaging platform services, using a messaging gateway;
receiving messaging instructions from an interaction control server, using a messaging gateway;
delivering messages to the user device using a selected messaging protocol, using a messaging gateway;
receiving the interaction from the user device comprising the phone number and contextual data, using an interaction control server;
maintaining persistent user identity profiles anchored to phone numbers as primary identifiers, using an interaction control server;
capturing an opt-in event associated with the interaction, using an interaction control server;
maintaining multi-state opt-in information governing messaging eligibility, using an interaction control server;
determining messaging protocol eligibility based on the multi-state opt-in information and capabilities retrieved from external messaging platform services, using an interaction control server;
selecting a messaging protocol based on the determined eligibility, using an interaction control server;
constructing capability-aware messages adapted to the selected messaging protocol, using an interaction control server;
assigning session identifiers to interactions and maintain session state, using an interaction control server;
instructing the messaging gateway to deliver messages using the selected messaging protocol, using an interaction control server; and
routing user interactions to one or more downstream lead destinations, using an interaction control server.

12. The method of claim 11, wherein the messaging gateway and the interaction control server operate on the same computing device.

13. The method of claim 11, wherein the persistent user identity profiles accumulate interaction history, device associations, protocol usage history, and opt-in state history across multiple sessions and campaigns.

14. The method of claim 11, wherein the multi-state opt-in information comprises multiple opt-in states indicating different messaging eligibility levels.

15. The method of claim 11, wherein the interaction control server is further configured to query external messaging platform capability endpoints using the phone number to retrieve capability profiles.

16. The method of claim 11, wherein the capability-aware message construction adapts message format and features to selected protocol capabilities while preserving interaction intent.

17. The method of claim 11, wherein the interaction control server is further configured to, upon receiving a delivery failure notification, retrieve session context using the session identifier and regenerate the message for an alternative messaging protocol while maintaining the session identifier.

18. The method of claim 11, wherein the interaction control server is further configured to apply inference logic to accumulated identity data to derive implicit user preferences.

19. The method of claim 11, wherein the multiple messaging protocols comprise Rich Communication Services (RCS), Short Message Service (SMS), and Multimedia Messaging Service (MMS).

20. The method of claim 11, wherein the interaction control server is further configured to store the selected messaging protocol with the persistent user identity profile and the session identifier.
